(19) United States
(12) Patent Application Publication
(10) Pub. No.: US 2024/0425148 A1
(43) Pub. Date: Dec. 26, 2024

(54) ARTICULATED MECHANICAL CONNECTORS AND PROCESSES FOR USING SAME

(71) Applicant: SOFEC, INC., HOUSTON, TX (US)

(72) Inventors: QUOC ANH DANG, Cypress, TX (US); STEVEN ESKRIDGE, Waller, TX (US); JEAN-BENOIT LEGA, Sugar Land, TX (US); BRIAN SCOTT BAKER, Houston, TX (US); STEPHEN P. LINDBLADE, Waller, TX (US); HAO YU, Katy, TX (US); ALAN R. CORDY, Katy, TX (US)

(73) Assignee: SOFEC, INC., HOUSTON, TX (US)

(21) Appl. No.: 18/749,777

(22) Filed: Jun. 21, 2024

Related U.S. Application Data
(60) Provisional application No. 63/522,585, filed on Jun. 22, 2023.
(60) Provisional application No. 63/535,932, filed on Aug. 31, 2023.

(51) Int. Cl. B63B 21/50; B63B 21/16; B63B 21/18; B63B 21/20; B63B 21/24; B63B 22/02

(52) U.S. Cl. CPC B63B 21/50; B63B 21/18; B63B 21/20; B63B 21/24; B63B 21/16; B63B 2021/203; B63B 2021/505; B63B 22/021

(57) ABSTRACT

Articulated mechanical connectors and processes for using same. The connector can include a first connector part and a second connector part. The first connector part can include a gimbal table, first and second trunnions disposed on the gimbal table, a first arm, and a stopper assembly. The second connector part can include a second arm. The second arm can include one or more shoulders disposed between a first end and a second end of the second arm. The second arm can be configured to be at least partially disposed within an aperture defined by the first arm such that one of the one or more shoulders can engage with the stopper assembly.

### CROSS-REFERENCE TO RELATED APPLICATIONS

This application claims priority to U.S. Provisional Patent Application No. 63/522,585, filed on Jun. 22, 2023, and to U.S. Provisional Patent Application No. 63/535,932, filed on Aug. 31, 2023, which are both incorporated by reference herein.

### FIELD

Embodiments described generally relate to articulated mechanical connectors. More particularly, such embodiments relate to articulated mechanical connectors for use in connecting a first member to a second member, e.g., for connecting a link arm or a mooring line to a floating structure at an offshore site, and processes for using same.

### BACKGROUND

In the drilling, production, and transportation of offshore oil and gas and in the generation of electricity via offshore wind turbines, mooring systems have been used to connect floating production, storage, and offloading (FPSO) vessels, floating storage and offloading (FSO) vessels, barges, tankers, wind turbine support platforms, and other floating structures to mooring structures, e.g., mooring anchors secured to a seabed. Some conventional mooring systems are permanent, meaning the connected vessel, platform, or other floating structure can be maintained on location even in 100-year survival environmental conditions. Other conventional mooring systems are disconnectable, meaning the connected vessel, platform, or other floating structure can be disconnected and moved away from the mooring location to avoid severe weather events and conditions such as harsh seas, typhoons, hurricanes, and icebergs.

The process for connecting and disconnecting vessels, platforms, or other floating structures to the mooring structure via the conventional mooring systems is generally time consuming and requires complex systems and external intervention even in very limited sea states. These significant connect and disconnect sequence times can result in undesirable lost production time, injury, or worse.

There is a need, therefore, for improved articulated mechanical connectors for use in connecting two bodies together, e.g., for use in mooring a vessel, a platform, or other floating structure to a mooring structure at sea.

### SUMMARY

Articulated mechanical connector assemblies configured to provide an articulated connection between a first member and a second member and processes for using same are provided. In some embodiments, the connector assembly configured to provide an articulated connection between a first member and a second member can include a gimbal table. The gimbal table can define an aperture therethrough. An upper surface of the gimbal table can define a first bearing surface and a second bearing surface on a first pair of opposing sides of the gimbal table. The connector assembly can also include a first trunnion and a second trunnion disposed on a second pair of opposing sides of the gimbal table. The connector assembly can also include a first arm having a first end and a second end. The first arm can define an aperture therethrough from the first end to the second end. A third trunnion and a fourth trunnion can each be disposed toward the second end of the first arm. The connector assembly can also include a stopper assembly disposed on the first arm. The connector assembly can also include a second arm having a first end and a second end. The second arm can include a shoulder or two or more shoulders axially spaced apart from one another between the first end and the second end thereof. The first trunnion and the second trunnion can be aligned along a first axis. The third trunnion and the fourth trunnion can be aligned along a second axis. The first axis and the second axis can be substantially orthogonal or substantially perpendicular with respect to one another. The third trunnion and the first bearing surface can be rotatively engaged with one another. The fourth trunnion and the second bearing surface can be rotatively engaged with one another. At least a portion of the first arm can be disposed through the aperture defined by the gimbal table. The first arm ca be rotatable relative to the gimbal table about the second axis. The second arm can be configured to be partially disposed within the aperture defined by the first arm such that the shoulder or one of the two or more shoulders of the second arm can engage with the stopper assembly.

In some embodiments, a process for installing an offshore floating platform can include providing an offshore floating system. The offshore floating system can include a hull structure that can include a first column, a second column, and a third column connected to one another. Each column can include a first connector part of a corresponding connector assembly connected thereto. The offshore floating system can also include a first anchor, a second anchor, and a third anchor secured to the seabed. The offshore floating system can also include a first mooring line, a second mooring line, and a third mooring. Each mooring line can include a second connector part of the corresponding connector assembly connected to a first end thereof. A second end of the first, the second, and the third mooring lines can be configured to be attached to the first, the second, and the third anchors, respectively. The first connector part can include a first bearing block and a second bearing block disposed on the hull structure. The first connector part can also include a gimbal table that can define an aperture therethrough. An upper surface of the gimbal table can define a first bearing surface and a second bearing surface on a first pair of opposing sides of the gimbal table. A first trunnion and a second trunnion can be disposed on a second pair of opposing sides of the gimbal table. The first connector part can also include a first arm having a first end and a second end. A stopper assembly can be disposed on the first arm. The first arm can define an aperture therethrough from the first end to the second end and a third trunnion and a fourth trunnion can each disposed toward the second end of the first arm. The first trunnion and the second trunnion can be aligned along a first axis. The third trunnion and the fourth trunnion can be aligned along a second axis. The first axis and the second axis can be substantially orthogonal or substantially perpendicular with respect to one another. The first trunnion can be rotatively engaged with the first bearing block and the second trunnion can be rotatively engaged with the second bearing block. The third trunnion and the first bearing surface can be rotatively engaged with one another. The fourth trunnion and the second bearing surface can be rotatively engaged with one another. At least a portion of the first arm can be disposed through the aperture defined by the gimbal table. The first arm can be rotatable relative to the gimbal table about the second axis. The second connector part can include a second arm having a first end and a second end. The second arm can include a plurality of shoulders axially spaced apart from one another between the first end and the second end thereof. The second arm can be configured to be partially disposed within the aperture defined by the first arm such that one of the plurality of shoulders engages with the stopper assembly. The process can also include positioning the second arm of the second connector part connected to the first mooring line within the aperture defined by the first arm of the first connector part connected to the first column such that one of the plurality of shoulders of the second arm of the second connector part connected to the first mooring line can be engaged with the stopper assembly of the first connector part connected to the first column. The process can also include positioning the second arm of the of the second connector part connected to the second mooring line within the aperture defined by the first arm of the first connector part connected to the second column such that one of the plurality of shoulders of the second arm of the second connector part connected to the second mooring line can be engaged with the stopper assembly of the first connector part connected to the second column. The process can also include positioning the second arm of the of the second connector part connected to the third mooring line within the aperture defined by the first arm of the first connector part connected to the third column such that one of the plurality of shoulders of the second arm of the second connector part connected to the third mooring line can be engaged with the stopper assembly of the first connector part connected to the third column.

In some embodiments, a process for connecting a vessel floating on a surface of a body of water to a structure secured to a seabed can include maneuvering the vessel to a position sufficiently close to the structure. The vessel can include a lifting device and a first connector part disposed thereon. The lifting device can include a lifting line. The structure can include a second connector part connected thereto. The lifting line can be configured to be connected to the second connector part or the structure. The second connector part can be configured to be releasably connected to the first connector part such that a weight of the structure can be transmitted from the second connector part to the first connector part when the second connector part is connected to the first connector part. The process can also include connecting the lifting line to the second connector part or the structure. The process can also include raising the second connector part and the structure with the lifting device and the lifting line. The process can also include connecting the second connector part to the first connector part. A thrust can be applied to the vessel after connecting the lifting line to the second connector part or the structure and prior to connecting the second connector part to the first connector part.

### BRIEF DESCRIPTION OF THE DRAWINGS

The subject disclosure is further described in the detailed description that follows in reference to the drawings by way of non-limiting embodiments, in which like reference numerals represent similar parts throughout the embodiments shown in the drawings.

FIG. 1 depicts an isometric view of an illustrative mechanical joint or connector assembly that includes a gimbal table, a first arm, and a second arm, according to one or more embodiments described.

FIG. 2 depicts an exploded view of the connector assembly shown in FIG. 1.

FIG. 3 depicts an isometric view of another illustrative connector assembly that includes a gimbal table, a first arm, a second arm, a first bearing block, and a second bearing block, according to one or more embodiments described.

FIG. 4 depicts an exploded view of the connector assembly shown in FIG. 3.

FIG. 5 depicts a cross sectional view of the connector assembly shown in FIG. 3.

FIG. 6 depicts another cross-sectional view of the connector assembly shown in FIG. 3.

FIG. 7 depicts an isometric view of the gimbal table shown in FIGS. 1-6.

FIG. 8 depicts an isometric view of the first arm most clearly shown in FIG. 2.

FIG. 9 depicts an isometric view of the second arm shown in FIGS. 3 and 4.

FIG. 10 depicts an isometric view of another illustrative second arm that can be used with the gimbal table and the first arm shown in FIGS. 1-8, according to one or more embodiments described.

FIG. 11 depicts an isometric view of another illustrative connector assembly that includes a gimbal table, a first arm, a second arm, and a stopper assembly disposed toward a second end of the first arm and engaged with a shoulder of the second arm, according to one or more embodiments described.

FIGS. 12 and 13 depict an isometric view and a cross sectional view of another illustrative connector assembly that includes a gimbal table, a first arm, a second arm, and a stopper assembly disposed toward a second end of the first arm that includes a split ring and a retainer ring, according to one or more embodiments described.

FIGS. 14 and 15 depict an isometric view and a cross sectional view of another illustrative connector assembly that includes a gimbal table, a first arm, a second arm, and a stopper assembly disposed toward a first end of the first arm that includes a split ring and a retainer ring, according to one or more embodiments described.

FIG. 16 depicts a side elevation view of an illustrative yoke mooring system that includes the connector assembly shown in FIGS. 3-9, a lifting device, and a lifting line that are orientated along a vertical axis to facilitate the connection and disconnection of the yoke mooring system to a vessel via the connector assembly, according to one or more embodiments described.

FIG. 17 depicts a side elevation view of another illustrative yoke mooring system that includes the mechanical joint shown in FIGS. 3-9, a lifting device, and a lifting line that are orientated at an angle relative to a vertical axis to facilitate the connection and disconnection of the yoke mooring system to a vessel via the connector assembly, according to one or more embodiments described.

FIG. 18 depicts a close-up side elevation view of the lifting device, the lifting line, and the connector assembly shown in FIG. 16.

FIG. 19 depicts a close-up side elevation view of the lifting device, the lifting line, and the connector assembly shown in FIG. 17.

FIGS. 20-26 depict an illustrative connection process for connecting a vessel to a disconnectable yoke mooring system via a connector assembly, according to one or more embodiments.

FIGS. 27-32 depict an illustrative process for installing an offshore floating platform system that includes connecting a floating hull structure to a plurality of anchors secured to a seabed via a plurality of mooring lines, according to one or more embodiments described.

### DETAILED DESCRIPTION

A detailed description will now be provided. Each of the appended claims defines a separate invention, which for infringement purposes is recognized as including equivalents to the various elements or limitations specified in the claims. Depending on the context, all references to the “invention”, in some cases, refer to certain specific or preferred embodiments only. In other cases, references to the “invention” refer to subject matter recited in one or more, but not necessarily all, of the claims. It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the figures provided herein. This repetition is for the purpose of simplicity and clarity and does not in itself dictate a relationship between the various exemplary embodiments and/or configurations discussed in the Figures. Moreover, the formation of a first feature over or on a second feature in the description that follows includes embodiments in which the first and second features are formed in direct contact and also includes embodiments in which additional features are formed interposing the first and second features, such that the first and second features are not in direct contact. The exemplary embodiments presented below may be combined in any combination of ways, i.e., any element from one exemplary embodiment may be used in any other exemplary embodiment, without departing from the scope of the disclosure. The figures are not necessarily drawn to scale and certain features and certain views of the figures can be shown exaggerated in scale or in schematic for clarity and/or conciseness.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Also, the naming convention used herein is not intended to distinguish between components that differ in name but not function. Furthermore, in the following discussion and in the claims, the terms “including” and “comprising” are used in an open-ended fashion, and thus should be interpreted to mean “including, but not limited to.”

All numerical values in this disclosure are exact or approximate values (“about”) unless otherwise specifically stated. Accordingly, various embodiments of the disclosure may deviate from the numbers, values, and ranges disclosed herein without departing from the intended scope.

Further, the term “or” is intended to encompass both exclusive and inclusive cases, i.e., “A or B” is intended to be synonymous with “at least one of A and B,” unless otherwise expressly specified herein. The indefinite articles “a” and “an” refer to both singular forms (i.e., “one”) and plural referents (i.e., one or more) unless the context clearly dictates otherwise. The terms “up” and “down”; “upward” and “downward”; “upper” and “lower”; “upwardly” and “downwardly”; “above” and “below”; and other like terms used herein refer to relative positions to one another and are not intended to denote a particular spatial orientation since the apparatus and methods of using the same may be equally effective at various angles or orientations.

It should also be understood that the phrases “disposed therein”, “disposed within”, “disposed on” and other similar phrases, when describing a component, e.g., a second arm, describe the component as being partially disposed therein/within/on or completely disposed therein/within/on. For example, if the component is a second arm disposed within a bore or an aperture defined by a first arm, the second arm can be disposed partially within the aperture or completely within the aperture. In another example, if the component is a stopper assembly disposed on a second end of a first arm, the phrase “the stopper assembly can be disposed on the second end of the arm” means the stopper assembly can be partially disposed on the second end of the arm or completely on the second end of the arm.

The terms “rotate”, “rotation”, “rotatable”, and “rotating” are used interchangeably and mean partial or unlimited rotation of a body about an axis of rotation.

The terms “orthogonal” and “orthogonally” refer to two lines or vectors that are not coplanar and therefore do not intersect but can appear to be perpendicular when viewed from a particular angle. For example, a first line being orthogonal to a second line, the first line can lie in a first plane and the second line can lie in a second plane, where the first and second planes are parallel with respect to one another and the first line and the second line are oriented at 90 degrees with respect to one another when viewed along an axis that is normal to the first and second planes. Further is should be understood that the term “substantially” when used in the context of “substantially orthogonal” means the first and second lines are orientated at angles of about 80 degrees, about 83 degrees, about 85 degrees, about 87 degrees, or about 89 degrees to, about 91 degrees, about 93 degrees, about 95 degrees, about 97 degrees, or about 100 degrees with respect to one another when viewed along an axis that is normal to the first and second planes.

The terms “perpendicular” and “perpendicularly”, as used herein, refer to two lines or vectors that are coplanar and, therefore, do intersect one another at a 90 degree angle. Further, the term “substantially” when used in the context of “substantially perpendicular” means a first line and a second line are orientated at angles of about 80 degrees, about 83 degrees, about 85 degrees, about 87 degrees, or about 89 degrees to, about 91 degrees, about 93 degrees, about 95 degrees, about 97 degrees, or about 100 degrees with respect to one another. Further, the term “substantially” when used in the context of “substantially parallel” means an axis and a plane (e.g., the surface of a body of water) are orientated at angles of about 160 degrees, about 165 degrees, about 170 degrees, about 175 degrees, or about 180, or about 185 degrees, or about 190 degrees, or about 195 degrees, or about 200 degrees with respect to one another.

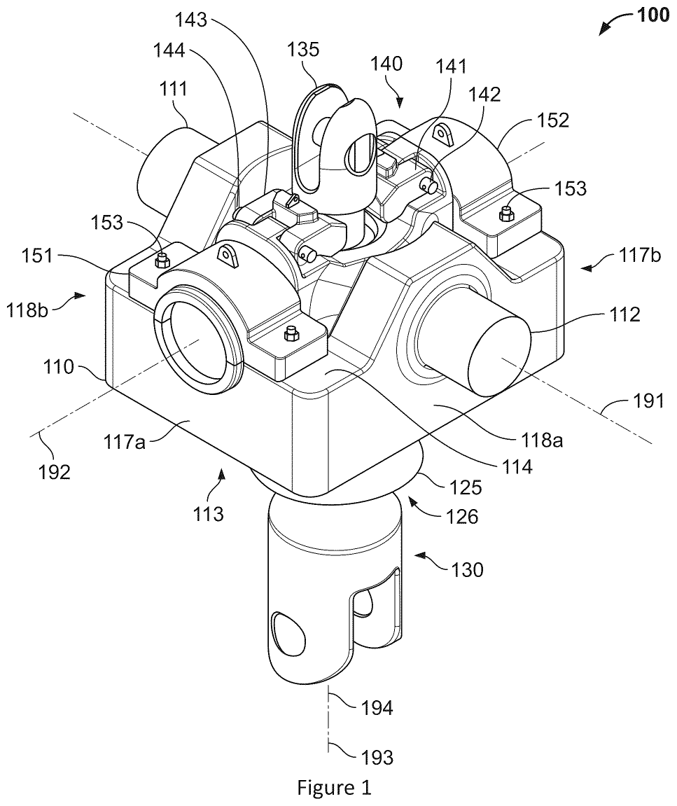

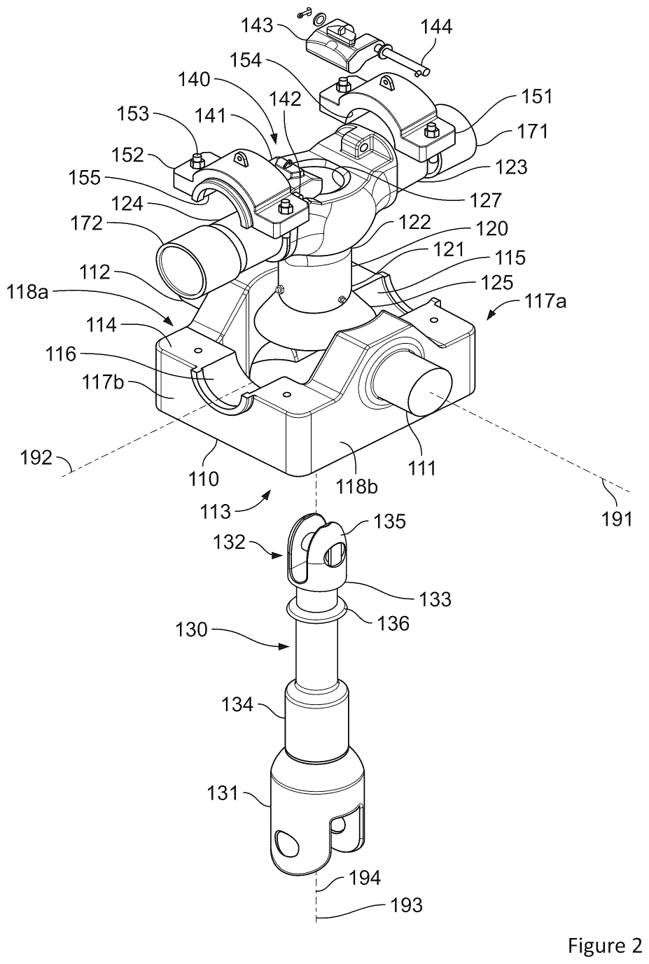

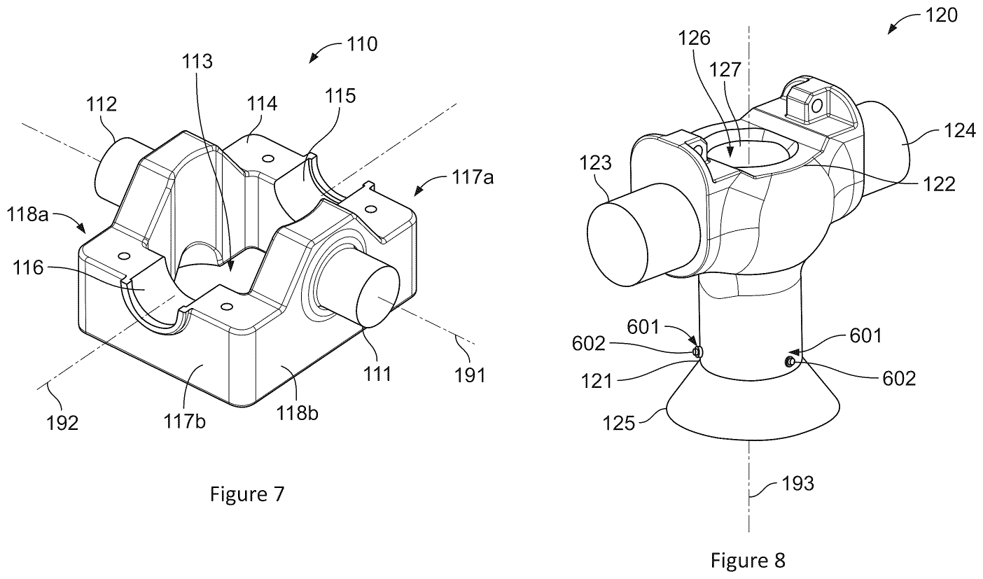

FIGS. 1 and 2 depict an isometric view and an exploded view, respectively, of an illustrative mechanical joint or connector assembly 100 that includes a gimbal table 110, a first arm 120, a stopper assembly 140, and a second arm 130, according to one or more embodiments. FIG. 7 depicts an isometric view of the gimbal table 110 shown in FIGS. 1 and 2. FIG. 8 depicts an isometric view of the first arm 120 most clearly shown in FIG. 2.

Referring to FIGS. 1, 2, 7, and 8 collectively, in some embodiments, the connector assembly 100 can be configured to provide an articulated connection between a first member and a second member. The gimbal table 110 can define a bore or an aperture 113 therethrough. The gimbal table 110 can have an upper surface 114 that can define a first bearing surface 115 and a second bearing surface 116 on a first pair of opposing sides 117a, 117b, respectively, of the gimbal table 110. In some embodiments, the connector assembly 100 can include a first trunnion 111 and a second trunnion 112 disposed on a second pair of opposing sides 118b, 118a, respectively, of the gimbal table 110. The first arm 120 can have a first end 121 and a second end 122. The first arm 120 can define a bore or an aperture 126 therethrough from the first end 121 to the second end 122. In some embodiments, the first arm 120 can include a third trunnion 123 and a fourth trunnion 124 disposed toward the second end 122 of the first arm 120. In some embodiments, the stopper assembly 140 can be disposed on the first arm 120. In some embodiments, the second arm 130 can have a first end 131 and a second end 132. In some embodiments, the second end 132 of the second arm 130 can include a shoulder 133.

In some embodiments, the first trunnion 111 and the second trunnion 112 can be aligned along a first axis 191. In some embodiments, the third trunnion 123 and the fourth trunnion 124 can be aligned along a second axis 192. In some embodiments the first axis 191 and the second axis 192 can be orthogonal or substantially orthogonal or perpendicular or substantially perpendicular with respect to one another. In some embodiments, the third trunnion 123 and the first bearing surface 115 can be rotatively engaged with one another and the fourth trunnion 124 and the second bearing surface 116 can be rotatively engaged with one another. In some embodiments, at least a portion of the first arm 120 can be disposed through the aperture 113 defined by the gimbal table 110. In some embodiments, the first arm 120 can be rotatable relative to the gimbal table 110 about the second axis 192. In some embodiments, the second arm 130 can be configured to be partially disposed within the aperture 126 defined by the first arm 120 such that the shoulder 133 can engage with the stopper assembly 140. As further described below, when the shoulder 133 engages with the stopper assembly 140, the stopper assembly 140 can secure the second arm 130 within the aperture 126 defined by the first arm 120 such that the second arm 130 can remain secured therein.

In some embodiments, the aperture 113 defined by the gimbal table 110 can have any desired cross-sectional shape or combination of cross-sectional shapes. In some embodiments, the aperture 113 can be elliptical, e.g., circular, or any suitable polygonal shape, e.g., rectangular. In some embodiments, the first trunnion 111 and the second trunnion 112 can be disposed, formed, or otherwise located on the second pair of opposing sides 118b, 118a, of the gimbal table 110. The first trunnion 111 and the second trunnion 112 can extend from the second set of opposing sides 118b, 118a of the gimbal table 110. In some embodiments, the first trunnion 111 and the second trunnion 112 can have a cylindrical shape or a circular outer cross-section when looking at side 118b or 118a of the gimbal table 110. In such embodiments, a central axis of the first trunnion 111 and a central axis of the second trunnion 112 can be aligned or colinear with the first axis 191.

In some embodiments, the first bearing surface 115, the second bearing surface 116, or both can be curved. In some embodiments, the first bearing surface 115 and the second bearing surface 116 can have a semi-circular cross-section when viewed looking at side 117a or 117b, respectively, of the gimbal table 110.

In some embodiments, at least a portion of the first arm 120 can have a circular cross-section when viewed along a longitudinal axis 193 of the first arm 120. In other embodiments, not shown, at least a portion of the first arm 120 can have a non-circular cross-section when viewed along a longitudinal axis 193 of the first arm 120. In other embodiments, not shown, at least a portion of the first arm 120 can have a triangular cross-section, a rectangular cross-section, a pentagonal cross-section, or hexagonal cross section, or an oval or elliptical cross section when viewed along the longitudinal axis 193 of the first arm 120. In some embodiments, a central axis through the aperture 126 defined by the first arm 120 can be aligned with the longitudinal axis 193 of the first arm 120. In some embodiments, an interior or inner surface 127 of the first arm 120 can have a cylindrical shape or a circular cross section when viewed along the longitudinal axis 193 of the first arm 120. In some embodiments, the first arm 120 can include a guide funnel 125 disposed toward the first end 121 of the first arm 120. In some embodiments, the guide funnel 125 can have a frustoconical interior surface such that an interior surface 128 of the guide funnel 125 can be aligned with or concentric with the interior surface 127 of the first arm 120.

In some embodiments, the third trunnion 123 and the fourth trunnion 124 can be rigidly connected to, attached, or otherwise disposed toward the second end 122 of the first arm 120. In some embodiments, the third trunnion 123 and the fourth trunnion 124 can be opposed to one another and can be perpendicular with the longitudinal axis 193 of the first arm 120. In some embodiments, a central axis of the third trunnion 123 and a central axis of the fourth trunnion 124 can be aligned along or colinear with the second axis 192 when the third trunnion 123 and the fourth trunnion 124 are engaged with the first bearing surface 115 and the second bearing surface 116, respectively. In some embodiments, the second axis 192 and the longitudinal axis of the first arm 193 can be perpendicular to one another. In some embodiments, the third trunnion 123 and the fourth trunnion 124 can each have a cylindrical shape or a circular outer cross-section when viewed along the second axis 192. In some embodiments, the third trunnion 123 and the fourth trunnion 124 can be configured to rotatively engage with the first bearing surface 115 and the second bearing surface 116, respectively, such that the third trunnion 123, the fourth trunnion 124 and the first arm 120 can rotate relative to the gimbal table 110 about the second axis 192.

In some embodiments, when the third trunnion 123 and the fourth trunnion 124 are engaged with the first bearing surface 115 and the second bearing surface 116, respectively, the first axis 191 and the second axis 192 can be orthogonal or substantially orthogonal with respect to one another. In other embodiments, when the third trunnion 123 and the fourth trunnion 124 are engaged with the first bearing surface 115 and the second bearing surface 116, respectively, the first axis 191 and the second axis 192 and can be perpendicular or substantially perpendicular with respect to one another. In some embodiments, when the third trunnion 123 and the fourth trunnion 124 are engaged with the first bearing surface 115 and the second bearing surface 116, respectively, the first axis 191 and the second axis 192 can lie in the same plane and intersect one another at right angles with respect to one another. In other embodiments, when the third trunnion 123 and the fourth trunnion 124 are engaged with the first bearing surface 115 and the second bearing surface 116, respectively, the first axis 191 and the second axis 192 can lie in different planes that are parallel with respect to one another and appear to be perpendicular when viewed from a position that is normal to the two planes.

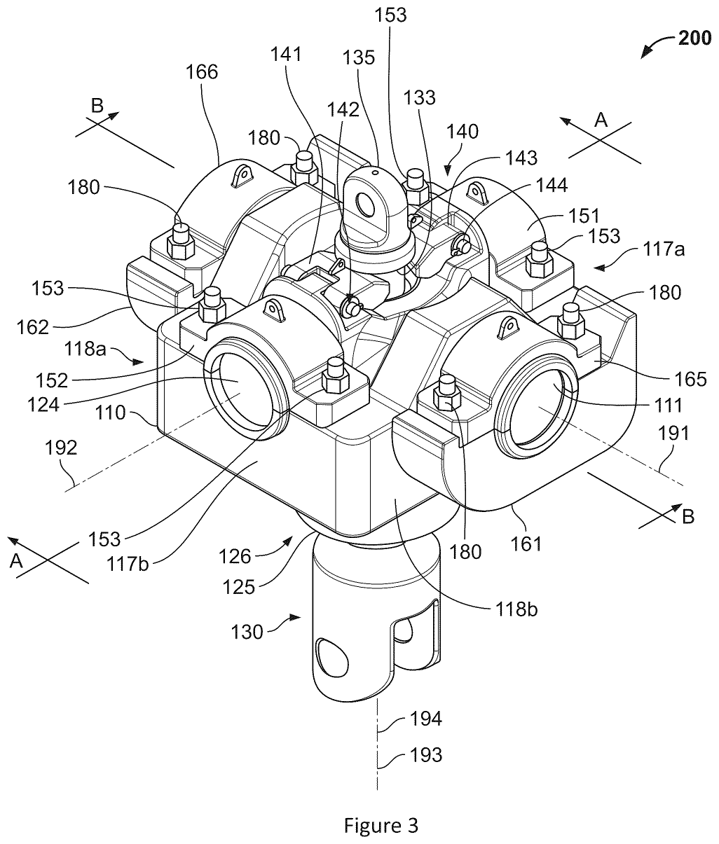

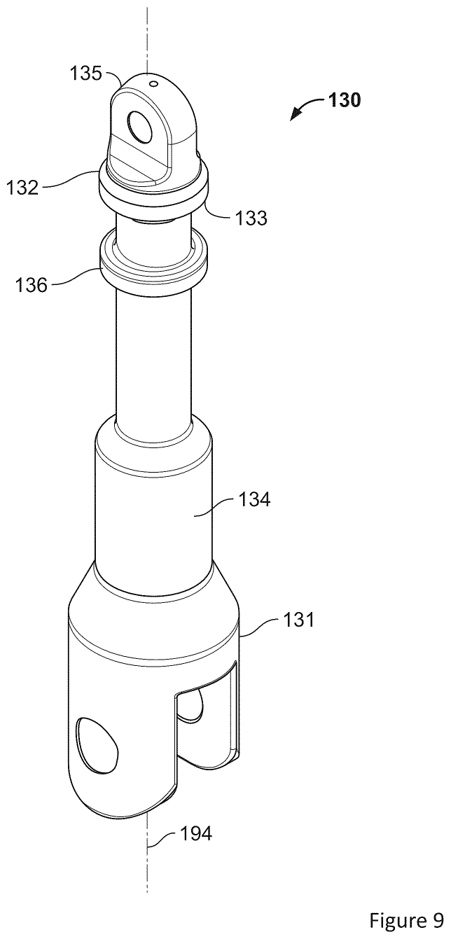

In some embodiments, the second arm 130 can have a longitudinal axis 194. In some embodiments, at least a portion of the second arm 130 can be configured to be inserted into the first arm 120 by positioning the second end 132 of the second arm 130 near the first end 121 of the first arm 120 and then pulling, pushing, urging, or otherwise moving the second arm 130 along the longitudinal axis 193 of the first arm 120 such that the second end 132 of the second arm 130 moves toward the second end 122 of the first arm 120. In some embodiments, the first arm 120 can be configured to at least partially rotate about the first axis 191 and/or the second axis 192 such that the longitudinal axis 193 of the first arm 120 aligns with the longitudinal axis 194 of the second arm 130 as the second arm 130 is inserted, pulled, or pushed into or through the aperture 126 defined by the first arm 120. In some embodiments, the shoulder 133 of the second arm 130 can be configured as a fully circular ring or a segmented ring. In some embodiments, the shoulder 133 can be formed on the second end 132 of the second arm 130. In other embodiments, the shoulder 133 can be welded on or otherwise disposed on the second end 132 of the second arm 130. In some embodiments, the second arm 130 can include a lifting apparatus 135, e.g., a clevis (as shown on FIGS. 1, 2, 5 and 6), a padeye, (as shown in FIGS. 3, 4 and 9) a lifting lug, or other similar structure, disposed on the second end 132 thereof that can be attached or connected to a lifting line or a pull-in line, not shown. As shown, the second arm 130 includes a clevis type lifting device 135 disposed on the second end 132 thereof. In some embodiments, the second arm 130 can be configured to be at least partially disposed within the aperture 126 defined by the first arm 120 by pulling the second end 132 of the second arm 130 at least partially through the guide funnel 125 and the aperture 126 defined by the first arm 120.

In some embodiments, the stopper assembly 140 can be disposed on or toward the second end 122 of the first arm 120. In some embodiments, the stopper assembly 140 can include one or more flapper plates (two are shown) 141, 143. In some embodiments, each flapper plate 141, 143 can be rotatively connected to the second end 122 of the first arm 120 via a mechanical fastener, for example a pin or bolt 142, 144 or similar arrangement. The connector assembly 100 can be configured to transfer a load from the second arm 130 to the first arm 120 via the one or more of flapper plates 141, 143.

In other embodiments, the stopper assembly 140 can be configured as a split ring arrangement. In some embodiments, the split ring arrangement can be configured to engage with the first end 121 of the first arm 120 and the shoulder 133 of the second arm 130 such that the second arm 130 can be supported by the first arm 120. In some embodiments, the split ring can be manually positioned between the first end 121 of the first arm 120 and the shoulder 133 of the second arm 130. In other embodiments, the split ring can be positioned with hydraulic cylinders or electric actuators between the first end 121 of the first arm 120 and the shoulder 133 of the second arm 130.

In some embodiments, the stopper assembly 140 can be configured to engage with the shoulder 133 of the second arm 130 such that a load or force can be transmitted from the second arm 130 to the first arm 120 and/or from the first arm 120 to the second arm 130. In some embodiments, when the stopper assembly 140 includes the flapper plates 141, 143, the flapper plates 141, 143 can be configured to open or rotate about the pins or bolts 142, 144 to allow the shoulder 133 of the second arm 130 to pass through or by the flapper plates 141, 143 as the second arm 130 is lifted, pulled, pushed, or otherwise moved though the aperture 126 of the first arm 120 from the first end 121 of the first arm 120 toward (and past) the stopper assembly 140. When the shoulder 133 of the second arm 130 has sufficiently moved through, past, beyond, or above the stopper assembly 140, the flapper plates 141, 143 can then rotate, either by gravity or by intervention, into a position such that the flapper plates 141, 143 are positioned to engage with the shoulder 133 of the second arm 130. The second arm 130 can then be moved in a direction from the second end 122 of the first arm 120 toward the first end 121 of the first arm 120 and lowered or otherwise moved into a position such that the shoulder 133 of the second arm 130 engages with the flapper plates 141, 143 such that the second arm 130 is supported by the stopper assembly 140. In some embodiments, the stopper assembly 140 can include rope(s), cable(s), chain(s), and/or actuator(s) that can be configured to open and close, e.g., rotate, the flapper plate 141 relative to the second end 122 of the first arm 120 to facilitate connection and/or disconnection of the second arm 130 to and/or from the first arm 120. For example, the flapper plates 141, 143 can be lifted into an open position to allow the shoulder 133 of the second arm 130 to pass through the stopper assembly 140. In some embodiments, the second arm 130 can be free to at least partially or completely rotate relative to the first arm 120 while being moved through the aperture 126 of the first arm and/or while supported or partially supported by the stopper assembly 140.

In other embodiments, the stopper assembly 140 can be configured as or with a power pack or hydraulic cylinder, not shown, that can exert a preload force between the first arm 120 and the second arm 130 such that the first arm 120 and the second arm 130 can rotate about the second axis 192 substantially together.

In some embodiments, the second arm 130 can include a first surface 134 configured to abut with an inner surface 127 of the first arm 120. In some embodiments, the first surface 134 can be disposed toward the first end 131 of the second arm 130. In some embodiments, the second arm 130 can include a second surface 136 disposed toward the second end 132 of the second arm 130 that can be configured to abut with the inner surface 127 of the first arm 120. In some embodiments, the first surface 134 and the second surface 136 of the second arm 130 can each have a cross sectional shape that can be configured to align, engage with, or otherwise correspond with the cross-sectional shape of the inner surface 127 of the first arm 120. For example, the inner surface 127 of the first arm 120 can have circular cross section when viewed along the longitudinal axis 193 of the first arm 120 and the first surface 134 and the second surface 136 of the second arm 130 can each have a circular cross section when viewed along the longitudinal axis 194 of the second arm 130. In some embodiments, the dimensions of the first surface 134 and the second surface 136 of the second arm 130 and the dimensions of the inner surface 127 of the first arm 120 can be such that the first arm 120 and the second arm 130 can rotate substantially together relative to the gimbal table 110 about the second axis 192. In some embodiments, the second surface 136 of the second arm 130 can serve the same function as the shoulder 133. As such, in some embodiments, the shoulder 133 and the second surface 136 can each be configured to engage with the stopper assembly 140 such that the second arm 130 can be supported by the stopper assembly 140.

In some embodiments, the first arm 120 can define one or more threaded bores 601 toward the first end 121 of the first arm 120. In some embodiments, the threaded bore(s) 601 can be orientated in a radial direction with respect to the longitudinal axis 193 of the first arm 120. In other embodiments, the threaded bore(s) 601 can be oriented at an angle with respect to the longitudinal axis 193 of the first arm 120, e.g., +/−5 degrees, +/−10 degrees, +/−15 degrees, +/−20 degrees, or more. In some embodiments, the first arm 120 can include one or more set screws 602. The set screw(s) 602 can be configured to be installed into a corresponding threaded bore 601 defined by the first arm 120. The set screw(s) 602 can be installed or tightened to secure or fix the second arm 130 relative to the first arm 120. When the set screw(s) 602 is/are installed or tightened such that the second arm 130 is secured or fixed relative to the first arm 120, the first arm 120 and the second arm 130 can rotate substantially together about the first axis. The term “rotate substantially together” means that the longitudinal axis 193 of the first arm 120 and the longitudinal axis 194 of the second arm 130 remain within about 0.1 degrees, about 0.5 degrees, or about 1 degree to about 1.5 degrees, about 2 degrees, about 3 degrees, or about 5 degrees of one another.

In some embodiments, the connector assembly 100 can also include a first bearing cap 151 and a second bearing cap 152. In some embodiments, the first bearing cap 151 and the second bearing cap 152 can be configured to be releasably attached to the gimbal table 110. In some embodiments, the first bearing cap 151 can be configured to capture or maintain the third trunnion 123 in an engaged position with the first bearing surface 115 and the second bearing cap 152 can be configured to capture or maintain the fourth trunnion 124 in an engaged position with the second bearing surface 116 such that movement of the third trunnion 123 and the fourth trunnion 124 can be restricted in a linear direction, e.g., in a direction parallel with the first axis 191 and/or in a direction parallel with the second axis 192 and/or in a direction normal to the upper surface 114 of the gimbal table 110. In some embodiments, the first bearing cap 151 and the second bearing cap 152 can be configured to be attached to the gimbal table 110 via a plurality of mechanical fasteners 153, for example, threaded cap screws or a combination threaded studs and nuts.

In some embodiments, the first bearing cap 151 can have an inner surface 154 that can be configured to rotatively engage with the third trunnion 123 and the second bearing cap 152 can have an inner surface 155 that can be configured to rotatively engage with the fourth trunnion 124. In some embodiments, the inner surface 154 of the first bearing cap 151 and the inner surface 155 of the second bearing cap 152 can each have a semi-circular cross-section when secured to the gimbal table 110 and viewed along the second axis 192. In some embodiments, when the first bearing cap 151 is secured to the gimbal table 110, the inner surface 154 of the first bearing cap 151 and the first bearing surface 115 can form a bearing surface that can have a circular cross-section. In some embodiments, when the second bearing cap 152 is secured to the gimbal table 110, the inner surface 155 of the second bearing cap 152 and the second bearing surface 116 can form a bearing surface that can have a circular cross-section.

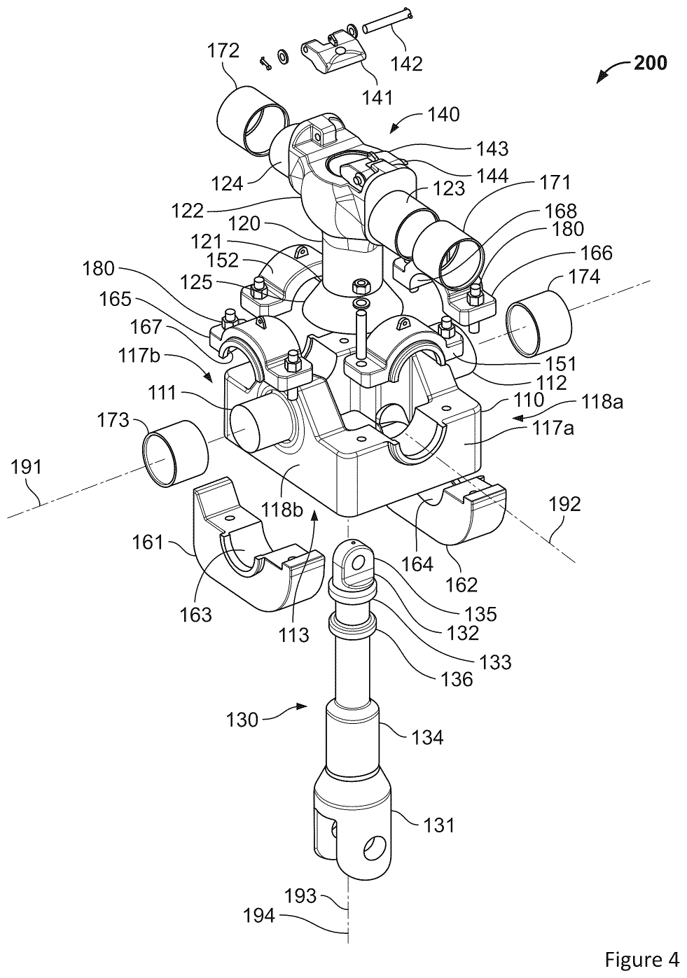

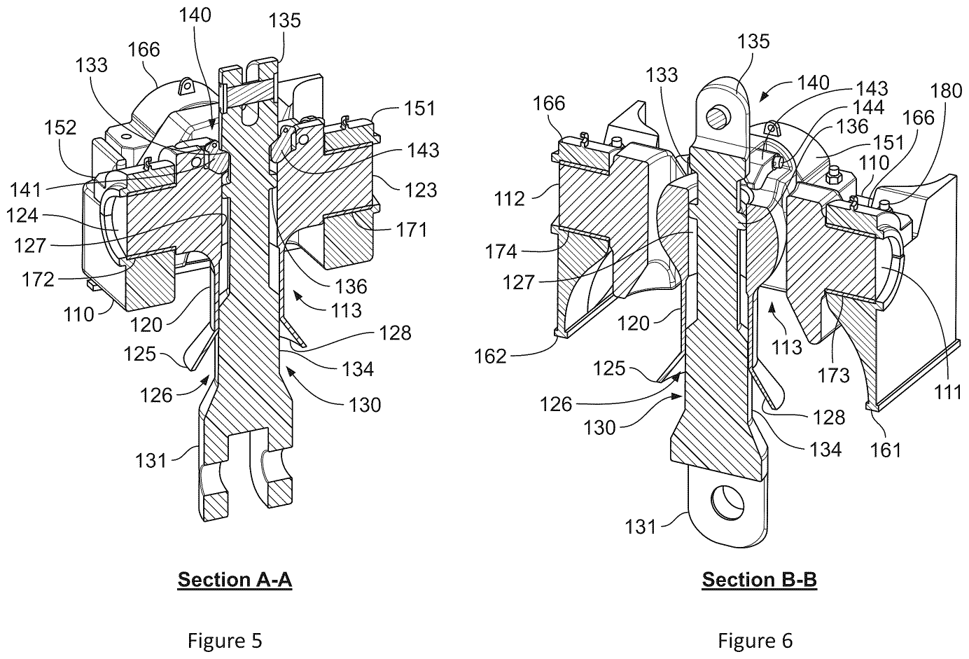

FIG. 3 depicts an isometric view of another illustrative connector assembly 200 that includes the gimbal table 110, the first arm 120, the second arm 130, a first bearing block 161, and a second bearing block 162, according to one or more embodiments. FIG. 4 depicts an exploded view of the connector assembly 200 shown in FIG. 3. FIG. 5 depicts a cross sectional view of the connector assembly 200 shown in FIG. 3. FIG. 6 depicts another cross-sectional view of the connector assembly 200 shown in FIG. 3. It should be noted that the second end 132 of the second arm 130 shown in FIGS. 5 and 6 has a different lifting device 135 disposed on the second end 132 thereof as compared to the lifting device 135 shown in FIGS. 3, 4, and 9. More particularly, the lifting device 135, as shown in FIGS. 5 and 6, is a padeye lifting device. Otherwise, the second arm 130 is the same as the second arm 130 shown in FIGS. 3, 4, and 9.

Referring to FIGS. 3-9, in some embodiments, the first and second bearing blocks 161, 162 can be configured to be attached, connected to, or otherwise disposed on a first member (not shown). The first end 131 of the second arm 130 can be configured to be attached, connected to, or otherwise disposed on a second member (not shown). In some embodiments, the first member can be a vessel, e.g., a ship, a barge, a tanker, or a floating platform; a fixed platform or tower; a dock; a coastal defense structure; or other similar floating or fixed structure. In some embodiments, the second member can be a vessel, e.g., a ship, a barge, a tanker, or a floating platform; a fixed platform or tower; a dock; a coastal defense structure; or other similar floating or fixed structure. For example, in some embodiments, the first member can be a vessel and the second member can be a fixed platform or tower; a dock; or a coastal defense structure. In another example, in some embodiments, the first member can be a fixed platform or tower; a dock; or a coastal defense structure and the second member can be a vessel. Coastal defense structures can be or can include, but are not limited to, a jetty, a groin, a seawall, a breakwater, or the like.

In some embodiments, the first trunnion 111 can be configured to rotatively engage with the first bearing block 161 and the second trunnion 112 can be configured to rotatively engage with the second bearing block 162. In some embodiments, a bearing surface 163 of the first bearing block 161 and a bearing surface 164 of the second bearing block 162 can each have a semi-circular cross section configured to receive the first trunnion 111 and the second trunnion 112, respectively. In some embodiments, the bearing surface 163 of the first bearing block 161 and the bearing surface 164 of the second bearing block 162 can each be configured to rotatively engage with the first trunnion 111 and the second trunnion 112, respectively, such that the first trunnion 111, the second trunnion 112, and the gimbal table 110 can rotate with respect to the first member while supporting a load or force. In some embodiments, the second arm 130 can be supported by the stopper assembly 140 disposed on the first arm 120, the first arm 120 can be supported by the gimbal table 110 via the first and second trunnions 111, 112, and the gimbal table 110 can be supported by the first and second bearing blocks 161, 162 such that the first arm 120, the second arm 130 and the gimbal table 110 can rotate about the first axis 191 and the first arm 120 and the second arm 130 can rotate about the second axis 192.

In some embodiments, the connector assembly 200 can include a third bearing cap 165 that can be configured to be releasably attached to the first bearing block 161 and a fourth bearing cap 166 that can be configured to be releasably attached to the second bearing block 162. In some embodiments, the third bearing cap 165 can have an inner surface 167 and the fourth bearing cap 166 can have an inner surface 168. In some embodiments, the third bearing cap 165 can be configured to be attached to the first bearing block 161 and to capture or maintain the first trunnion 111 in an engaged position between the bearing surface 163 of the first bearing block 161 and the inner surface 167 of the third bearing cap 165. Similarly, the fourth bearing cap 166 can be configured to be attached to the second bearing block 162 and to capture or maintain the second trunnion 112 in an engaged position between the bearing surface 164 of the second bearing block 162 and the inner surface 168 of the fourth bearing cap 164. In such embodiments, movement of the first trunnion 111 and the second trunnion 112 can be restricted in a linear direction, e.g., in a direction parallel with the first axis 191 and/or in a direction parallel with the second axis 192 and/or in a direction normal to the bearing surface 163 of the first bearing block 161 and/or in a direction normal to the bearing surface 164 of the second bearing block 162. In some embodiments, the third bearing cap 165 can be configured to be attached to the first bearing block 161 and the fourth bearing cap 166 can be configured to be attached to the second bearing block 162 via one or more mechanical fasteners 180, for example threaded cap screws or a combination threaded studs and nuts.

In some embodiments, the connector assemblies 100 and/or 200 can include a first bushing 171 disposed between the third trunnion 123 and the first bearing surface 115 and the inner surface 154 of the first bearing cap 151, and a second bushing 172 disposed between the fourth trunnion 124 and the second bearing surface 116 and the inner surface 155 of the second bearing cap 152. In some embodiments, the connector assembly 200 can include a third bushing 173 disposed between the first trunnion 111 and the bearing surface 163 of the first bearing cap 161 and the inner surface 167 of the third bearing cap 165, and a fourth bushing 174 disposed between the second trunnion 112 and the bearing surface 164 of the second bearing block 162 and the inner surface 168 of the fourth bearing cap 166. As used herein, the term “bushing” refers to any sleeve, shim, liner, inlay, pad, or any other structure configured to reduce friction and/or wear between an outer surface of a trunnion or cylinder or other structure, and an inner surface of a bore the trunnion or cylinder is at least partially disposed within. In some embodiments, the first bushing 171, the second bushing 172, the third bushing 173, and/or the fourth bushing 174 can be manufactured from bronze, brass, a polymer, a fiber reinforced composite material, or any other suitable material.

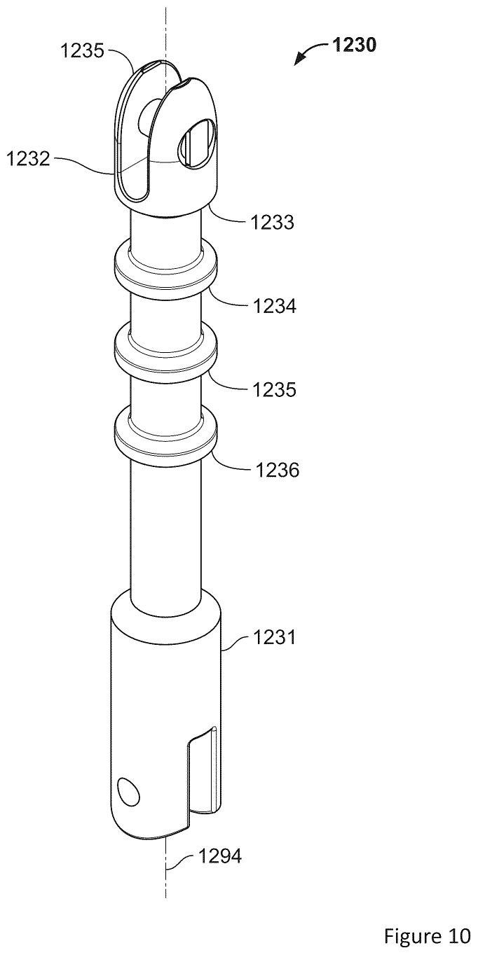

FIG. 10 depicts an isometric view of another illustrative second arm 1230 that can be used in the connector assemblies 100 and/or 200 shown in FIGS. 1-8, according to one or more embodiments. In some embodiments, the second arm 1230 can have a first end 1231 and a second end 1232. In some embodiments, the second arm 1230 can include a plurality of shoulders (four are shown, 1233, 1234, 1235, 1236) located between ch first end 1231 and the second end 1232 thereof. The plurality of shoulders 1233, 1234, 1235, 1236 can be axially spaced apart from one another between the first e end 1231 and the second end 1232 of the second arm 1230. In some embodiments, the axial spacing between the plurality of shoulders 1233, 1234, 1235, 1236 can be the same or different with respect to one another. In some embodiments, the second arm 1230 can include two, three, four, five, six, seven, eight, nine, ten, or more shoulders between the first end 1231 and the second end 1232 thereof.

In some embodiments, the second arm 1230 can be configured to be partially disposed within the aperture 126 defined by the first arm 120 such that one of the plurality of shoulders 1233, 1234, 1235, 1236 can engage with the stopper assembly 140. When the shoulder 1233, 1234, 1235, 1236 engages with the stopper assembly 140, the stopper assembly 140 can secure the second arm 1230 within the aperture 126 defined by the first arm 120 such that the second arm 1230 can remain secured therein.

In some embodiments, the second arm 1230 can have a longitudinal axis 1294. In some embodiments, at least a portion of the second arm 1230 can be configured to be inserted into the first arm 120 by positioning the second end 1232 of the second arm 1230 near the first end 121 of the first arm 120 and then pulling, pushing, urging, or otherwise moving the second arm 1230 along the longitudinal axis 193 of the first arm 120 such that the second end 1232 of the second arm 1230 moves toward the second end 122 of the first arm 120. In some embodiments, the first arm 120 can be configured to at least partially rotate about the first axis 191 and/or the second axis 192 such that the longitudinal axis 193 of the first arm 120 aligns with the longitudinal axis 1294 of the second arm 1230 as the second arm 1230 is inserted, pulled, or pushed into or through the aperture 126 defined by the first arm 120. In some embodiments, each of the plurality of shoulders 1233, 1234, 1235, 1236 of the second arm 1230 can independently be configured as a fully circular ring or a segmented ring.

In some embodiments, the shoulders 1233, 1234, 1235, 1236 can be an integral part of the second arm 1230, e.g., the second arm 1230 can be formed via a casting process, milled, or otherwise shaped from a single body or structure. In other embodiments, the shoulders 1233, 1234, 1235, 1236 can be welded on or otherwise disposed on the second arm 1230. In some embodiments, the second arm 1230 can include a lifting apparatus 1235, e.g., a clevis, a padeye, a lifting lug, or other similar structure, disposed on the second end 1232 thereof that can be attached or connected to a lifting line or a pull-in line, not shown. As shown, the second arm 1230 includes a clevis type lifting device 1235 disposed on the second end 1232 thereof. In some embodiments, the second arm 1230 can be configured to be at least partially disposed within the aperture 126 defined by the first arm 120 by pulling the second end 1232 of the second arm 1230 at least partially through the guide funnel 125 and the aperture 126 defined by the first arm 120.

In some embodiments, the stopper assembly 140 can be configured to engage with one of the plurality of shoulders 1233, 1234, 1235, 1236 of the second arm 1230 such that a load or force can be transmitted from the second arm 1230 to the first arm 120 and/or from the first arm 120 to the second arm 1230. In some embodiments, when the stopper assembly 140 includes the flapper plates 141, 143, the flapper plates 141, 143 can be configured to open or rotate about the pins or bolts 142, 144 to allow one of the plurality of shoulders 1233, 1234, 1235, 1236 of the second arm 1230 to pass through or by the flapper plates 141, 143 as the second arm 1230 is lifted, pulled, pushed, or otherwise moved though the aperture 126 of the first arm 120 from the first end 121 of the first arm 120 toward (and past) the stopper assembly 140. When the desired shoulder of the plurality of shoulders 1233, 1234, 1235, 1236 of the second arm 1230 has moved through, past, beyond, or above the stopper assembly 140, the flapper plates 141, 143 can then rotate, either by gravity or by intervention, into a position such that the flapper plates 141, 143 are positioned to engage with the desired should of the plurality of shoulders 1233, 1234, 1235, 1236 of the second arm 1230. The second arm 1230 can then be moved in a direction from the second end 122 of the first arm 120 toward the first end 121 of the first arm 120 and lowered or otherwise moved into a position such that the desired shoulder of the plurality of shoulders 1233, 1234, 1235, 1236 of the second arm 1230 engages with the stopper assembly 140 such that the second arm 1230 is supported by the stopper assembly 140. In some embodiments, the flapper plates 141, 143 can include a rope, cable, chain, or hydraulic cylinders that can be configured to open and close, e.g., rotate, the flapper plate 141 relative to the second end 122 of the first arm 120. In some embodiments, the second arm 1230 can be free to at least partially or completely rotate relative to the first arm 120 while being moved through the aperture 126 of the first arm and/or while supported or partially supported by the stopper assembly 140.

In other embodiments, the stopper assembly 140 can be configured as or with a power pack or hydraulic cylinder, not shown, that can exert a preload force between the first arm 120 and the second arm 1230 such that the first arm 120 and the second arm 1230 can rotate about the second axis 192 substantially together.

Although not shown, in some embodiments, the second arm 1230 can include a first surface 134 configured to abut with an inner surface 127 of the first arm 120, as described above with reference to the second arm 130. In some embodiments, the first surface 134 can be disposed toward the first end 1231 of the second arm 1230. Although not shown, in some embodiments, the second arm 1230 can also include a second surface 136 disposed about the second arm 1230 that can be configured to abut with the inner surface 127 of the first arm 120, as described above with reference to the second arm 1230. In some embodiments, the optional first surface 134 and/or second surface 136 of the second arm 1230 can each have a cross sectional shape that can be configured to align, engage with, or otherwise correspond with the cross-sectional shape of the inner surface 127 of the first arm 120. For example, the inner surface 127 of the first arm 120 can have a circular cross section when viewed along the longitudinal axis 193 of the first arm 120 and the first surface 134 and/or the second surface 136 of the second arm 1230 can have a circular cross section when viewed along the longitudinal axis 1294 of the second arm 1230. In some embodiments, the dimensions of the first surface 134 and the second surface 136 of the second arm 1230 and the dimensions of the inner surface 127 of the first arm 120 can be such that the first arm 120 and the second arm 130 can rotate substantially together relative to the gimbal table 110 about the second axis 192.

As described above, in some embodiments, the first end 121 of the first arm 120 can define one or more threaded bore(s) 601 and one or more corresponding set screws 602 configured to be installed into a corresponding threaded bore 601 defined by the first arm 120. When the set screw(s) 602 is/are installed or tightened such that the second arm 1230 is secured or fixed relative to the first arm 120, the first arm 120 and the second arm 1230 can rotate substantially together about the first axis.

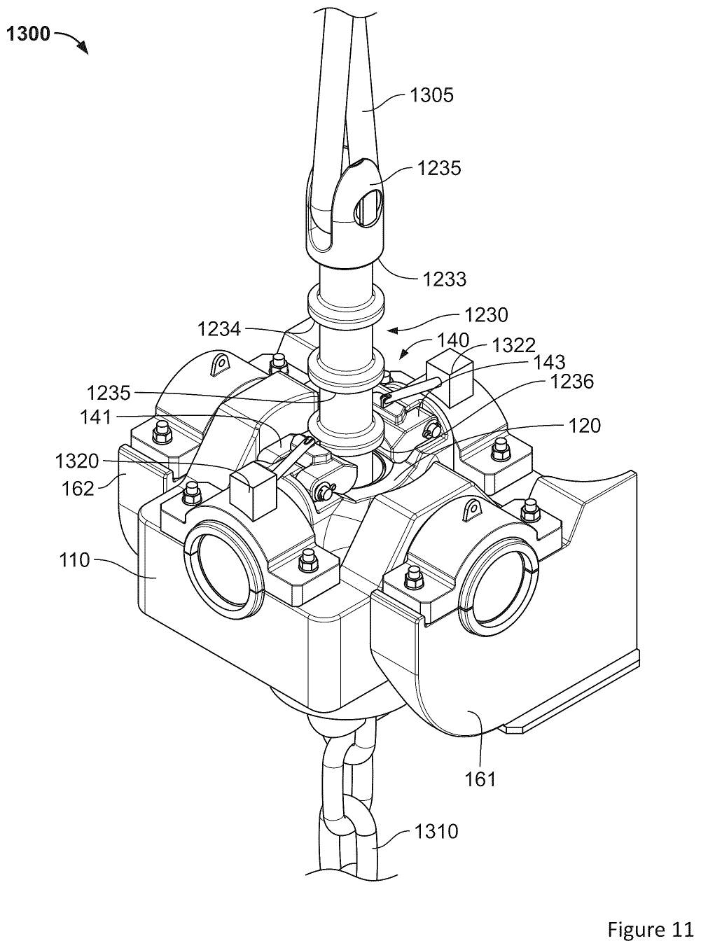

FIG. 11 depicts an isometric view of another illustrative mechanical joint or connector assembly 1300 that includes the gimbal table 110, the first arm 120, the second arm 1230, and a stopper assembly 140 disposed toward the second end 122 of the first arm 120 engaged with the shoulder 1236 of the second arm 1230, according to one or more embodiments. As also shown, a lifting line 1305 can be connected to the lifting apparatus 1235 of the second arm 1230. As also shown, an elongated member 1310, e.g., a link arm, a chain (as shown), cable, rope, or the like, can be connected to the first end 1231 of the second arm 1230.

In some embodiments, the stopper assembly 140 in the connector assembly 1300 can include one or more actuators that can be configured to open and/or close the flapper plates 141, 143. More particularly, as shown in FIG. 11, the stopper assembly can include a first actuator 1320 and a second actuator 1322 that can be configured to open and/or close the flapper plates 141, 143, respectively. In some embodiments, the actuators 1320, 1322 can be or can include, but are not limited to, hydraulic actuators, pneumatic actuators, electric actuators, or a combination thereof. In some embodiments, the actuators 1320, 1322 can be moved from a first position to a second and vice versa by moving a piston that can be connected to the flapper plates 141, 142 with sufficient force to cause the flapper plates 141, 142 to open and close. It should be understood that the connector assembly 100 and/or 200 can also include one or more actuators that can be configured to open and/or close the flapper plates 141, 143.

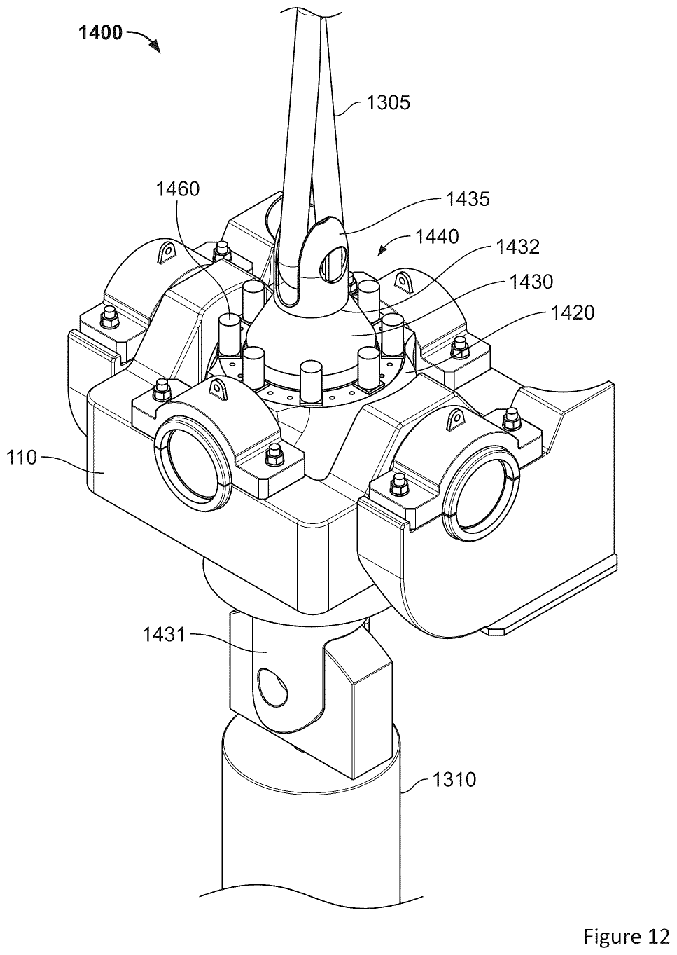

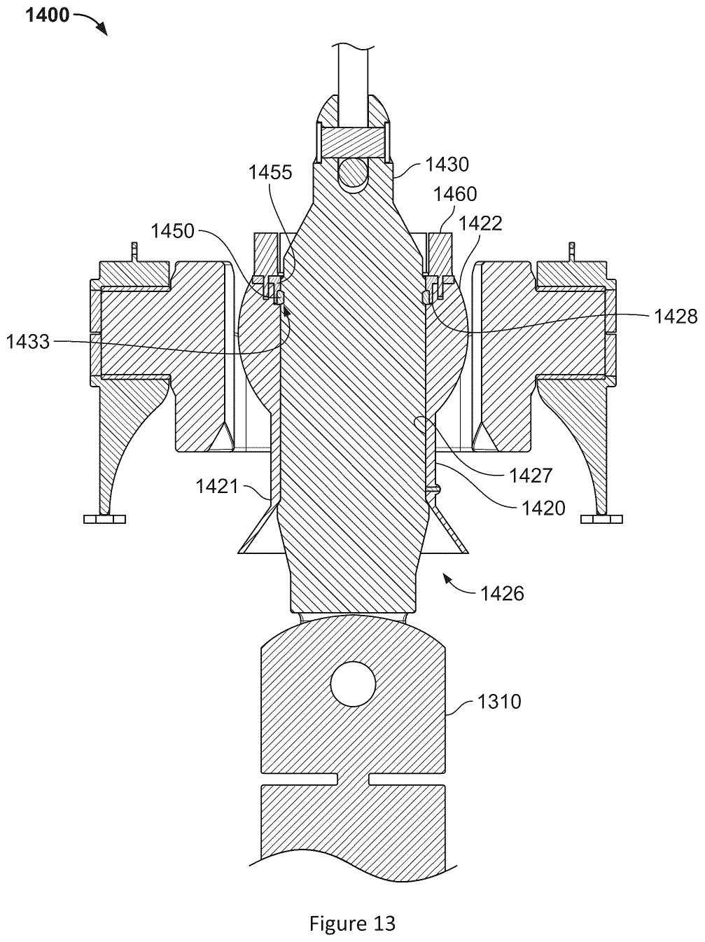

FIGS. 12 and 13 depict an isometric view and a cross sectional view, respectively, of another illustrative mechanical joint or connector assembly 1400 that includes the gimbal table 110, a first arm 1420, a second arm 1430, and a stopper assembly 1440 disposed toward a second end 1422 of the first arm 1420, according to one or more embodiments. The first arm 1420 can have a first end 1421 and a second end 1422. The first arm 1420 can also define a bore or an aperture 1426 therethrough from the first end 1421 to the second end 1422. The first arm 1420 can also include a shoulder 1428 disposed on an inner surface 1427 of the first arm 1420 that defines the aperture 1426 therethrough. The shoulder 1428 can extend partially or completely around the inner surface 1427 of the first arm 1420.

The second arm 1430 can have a first end 1431 and a second end 1432. The second arm 1430 can define one or more grooves 1433 (only one is shown). In some embodiments, however, the second arm 1430 can include one, two, three, four, five, six, seven, eight, nine, ten, or more grooves 1433 that can be axially spaced apart from one another between the first end 1431 and the second end 1432 of the second arm 1430. The groove(s) 1433 defined by the second arm 1430 can have an upper surface 1434 that can provide or otherwise serve as a shoulder. As such, the connector assembly 1400 can be configured to transfer a load from the second arm 1430 to the first arm 1420 via the shoulder 1434 of the second arm 1430, the split ring 1450, and the shoulder 1428 of the first arm 1420.

The second arm 1430 can include a lifting apparatus 1435, e.g., a clevis, a padeye, a lifting lug, or other similar structure, disposed on the second end 1432 thereof that can be attached or connected to a lifting line or a pull-in line 1305. As shown, the second arm 1430 includes a clevis type lifting device 1435 disposed on the second end 1432 thereof. In some embodiments, the second arm 1430 can be configured to be at least partially disposed within the aperture 1426 defined by the first arm 1420 by pulling the second end 1432 of the second arm 1430 at least partially through the aperture 1426 defined by the first arm 1420. As also shown, an elongated member 1310, e.g., a link arm (as shown), a chain, cable, rope, or the like, can be connected to the first end 1431 of the second arm 1430.

The stopper assembly 1440 can include a split ring 1450 and a retainer ring 1455. In some embodiments, the retainer ring 1455 can be moved from an unlocked position to a locked position via one or more actuators 1460. When the retainer ring 1455 is in the unlocked position, the split ring 1450 can be located above and supported on the shoulder 1428, which can permit the second arm 1430 to move into and out of the aperture 1426 defined by the first arm 1420. When the retainer ring 1455 is moved from the unlocked position to the locked position, the retainer ring 1455 can push, force, urge, or otherwise move the split ring 1450 partially into one of the one or more grooves 1433 defined by the second arm 1430 such that the split ring 1450 can be partially within the groove 1433 and partially on the shoulder 1428 to secure the second arm 1430 within the aperture 1426 defined by the first arm 1420. The mechanical joint 1400 can be configured to transfer a load from the second arm 1430 to the first arm 1420 via the groove or shoulder 1433 of the second arm 1430, the split ring 1450, and the shoulder 1428 of the first arm 1420. In some embodiments, the stopper assembly 1440 that includes the split ring 1450, the retainer ring 1455, and the actuator 1460 can be similar to the connector assemblies disclosed in U.S. Patent Application Publication No. 2023/0124086.

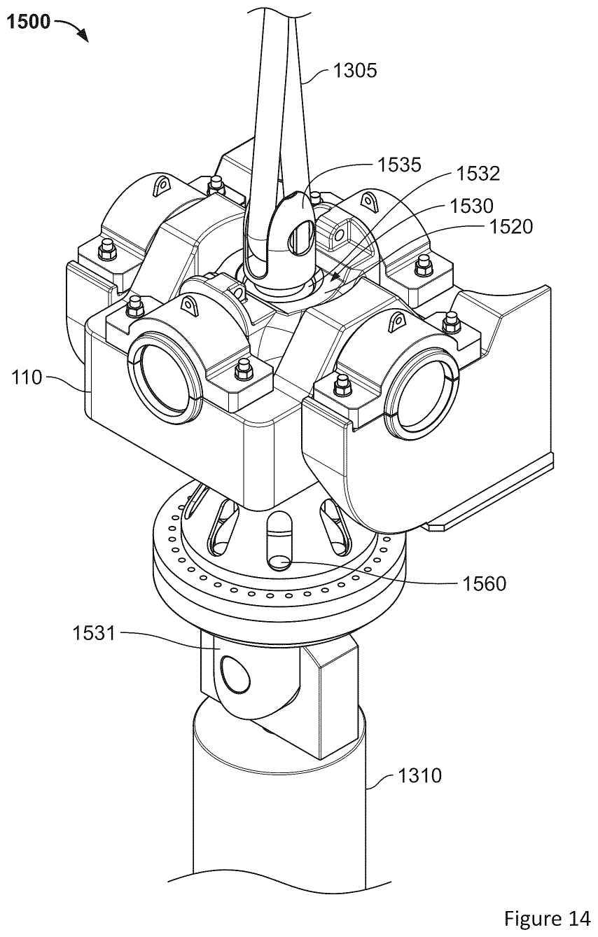

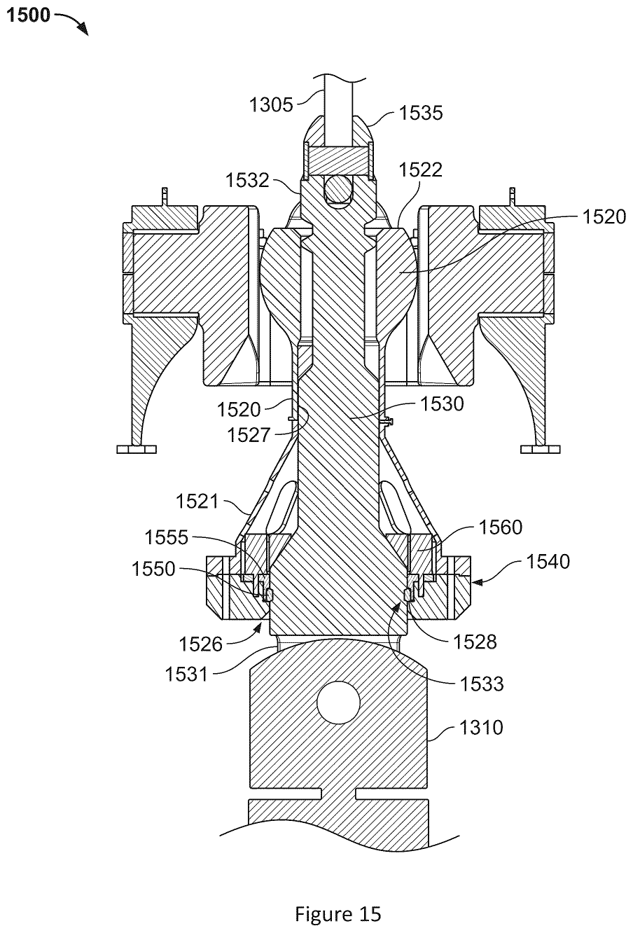

FIGS. 14 and 15 depict an isometric view and a cross sectional view, respectively, of another illustrative mechanical joint or connector assembly 1500 that includes the gimbal table 110, a first arm 1520, a second arm 1530, and a stopper assembly 1540 disposed toward a first end 1521 of the first arm 1520, according to one or more embodiments. The first arm 1520 can have a first end 1521 and a second end 1522. The first arm 1520 can also define a bore or an aperture 1526 therethrough from the first end 1521 to the second end 1522. The first arm 1520 can also include a shoulder 1528 disposed on an inner surface 1527 of the first arm 1520 that defines the aperture 1526 therethrough. The shoulder 1528 can extend partially or completely around the inner surface 1527 of the first arm 1520.

The second arm 1530 can have a first end 1531 and a second end 1532. The second arm 1530 can define one or more grooves 1533 (only one is shown). In some embodiments, however, the second arm 1530 can include one, two, three, four, five, six, seven, eight, nine, ten, or more grooves 1533 can be axially spaced apart from one another between the first end 1531 and the second end 1532 of the second arm 1530.

The second arm 1530 can include a lifting apparatus 1535, e.g., a clevis, a padeye, a lifting lug, or other similar structure, disposed on the second end 1532 thereof that can be attached or connected to a lifting line or a pull-in line 1305. As shown, the second arm 1530 includes a clevis type lifting device 1535 disposed on the second end 1532 thereof. In some embodiments, the second arm 1530 can be configured to be at least partially disposed within the aperture 1526 defined by the first arm 1520 by pulling the second end 1532 of the second arm 1530 at least partially through the aperture 1526 defined by the first arm 1520. As also shown, an elongated member 1310, e.g., a link arm (as shown), a chain, cable, rope, or the like, can be connected to the first end 1531 of the second arm 1530.

The stopper assembly 1540 can include a split ring 1550 and a retainer ring 1555. In some embodiments, the retainer ring 1555 can be moved from an unlocked position to a locked position via one or more actuators 1560. When the retainer ring 1555 is in the unlocked position, the split ring 1550 can be located above and supported on the shoulder 1528, which can permit the second arm 1530 to move into and out of the aperture 1526 defined by the first arm 1520. When the retainer ring 1555 is moved from the unlocked position to the locked position, the retainer ring 1555 can push, force, urge, or otherwise move the split ring 1550 partially into one of the one or more grooves 1533 defined by the second arm 1530 such that the split ring 1550 can be partially within the groove 1533 and partially on the shoulder 1528 to secure the second arm 1530 within the aperture 1526 defined by the first arm 1520. In some embodiments, the stopper assembly 1540 that includes the split ring 1550, the retainer ring 1555, and the actuator 1560 can be similar to the connector assemblies disclosed in U.S. Patent Application Publication No. 2023/0124086.

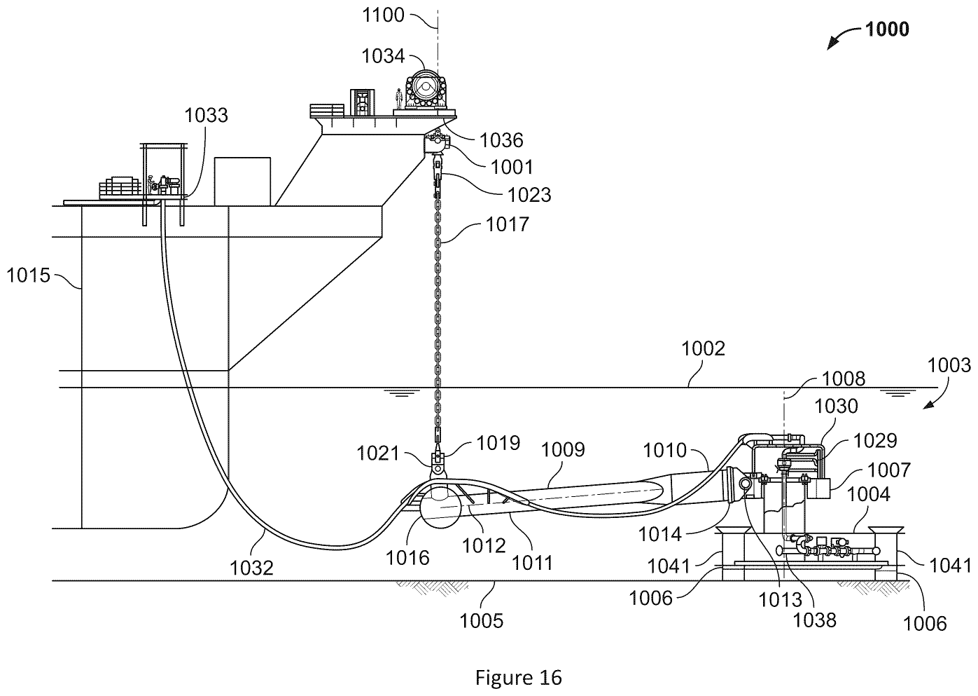

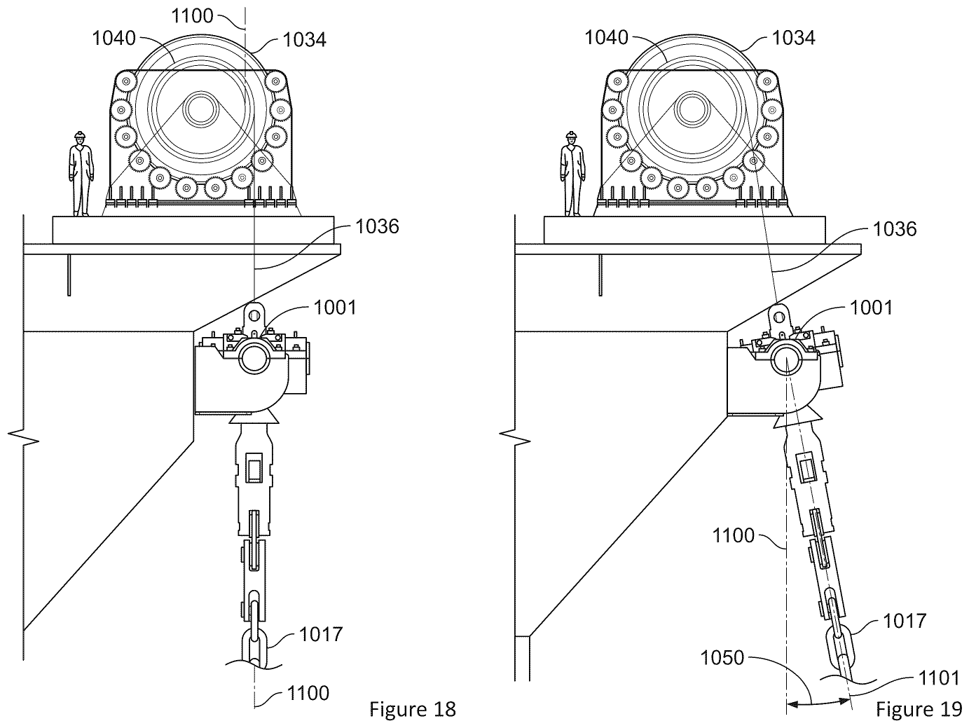

FIG. 16 depicts a side elevation view of an illustrative yoke mooring system 1000 that includes a mechanical joint or connector assembly 1001, a lifting device 1034, and a lifting line 1036 that can be orientated along a vertical axis 1100 to facilitate the connection and disconnection of the mechanical joint 1001, according to one or more embodiments. The mechanical joint or connector assembly 1001 can be the mechanical joint 100, 200, 1300, 1400, or 1500 described above. FIG. 18 depicts a close-up elevation view of the lifting device 1034, the lifting line 1036, and the mechanical joint 1001 shown in FIG. 16. It should be understood that the system 1000 can include two or more mechanical joints 1001, lifting devices 1034, and lifting lines 1036. In some embodiments, the system 1000 can include a first and a second mechanical joint 1001, a first and a second lifting device 1034, and a first and a second lifting line 1036.

The lifting device(s) 1034 can independently be or include, but are not limited to, a lifting device that utilizes a linear moving mechanism, a rotary torque mechanism, or a combination thereof. Suitable lifting devices that utilize a linear moving mechanism can be or can include, but are not limited to, chain jacks, strand jacks, linear winches, or the like. Suitable lifting devices that utilize a rotary torque mechanism can be or can include, but are not limited to, rotary winches that include one or more drums, e.g., single drum rotary winches or two drum rotary winches, a powered windlass, or the like. The windlass typically includes a chain wheel that includes, e.g., seven pockets, that can grip a chain, but the chain does not roll up on a drum but instead is moved off or onto the chain wheel as the chain is pulled in or let out. The lifting devices that utilize the linear moving mechanism can be powered via an internal combustion engine-hydraulic power unit or an electric hydraulic power unit. The lifting devices that utilize the rotary torque mechanism can be powered via electricity, hydraulics, an internal combustion engine, or combination thereof. In some embodiments, the lifting device 1034 can be an electrical winch, a hydraulic winch, a hydrocarbon, e.g., diesel, driven winch, or a combination thereof. In some embodiments, the lifting device 1034 can be a hydraulic winch that can include a hydraulic motor, and lowering the structure, e.g., the link arm 1017, with the winch can include back driving the hydraulic motor. In other embodiments, the lifting device 1034 can be a winch that includes a clutch and lowering the structure, e.g., the link arm 1017 with the winch and the lifting line can include at least partially releasing the clutch.

In some embodiments, the mooring system 1000 can also include a base structure 1004 configured to be secured to or disposed on a seabed 1005 below a surface 1002 of a body of water 1003. In some embodiments, the mooring system 1000 can be used to secure a vessel 1015 (or other floating structure) to the base structure 1004. In some embodiments, the base structure 1004 can be fixed or secured to the seabed 1005 with driven piles or suction piles 1006, as shown. More particularly, as shown, the base structure 1004 can include one or more pile sleeves 1041 that can be disposed about the one or more piles 1006 to fix or secure the base structure 1004 to the seabed 1005. In other embodiments, the base structure 1004 can be a gravity-based structure (not shown). The particular manner in which the base structure 1004 can be disposed on the seabed 1005 can be based, at least in part, on the seabed conditions at the site and/or expected loading forces transmitted thereto when the vessel 1015 is moored to the base structure 1004 via the mooring system 1000. It should be understood that when the base structure 1004 is a gravity-based structure, in some embodiments, the base structure 1004 can maintain an acceptable orientation with respect to the seabed 1005 without requiring the base structure 1004 to include driven piles, suction piles, or the like that can be physically connected to the seabed 1005.

The mooring system 1000 can also include a turntable 1007 that can be configured to be rotatively connected to the base structure 1004. The turntable 1007 can be configured to rotate about a vertical or a substantially vertical axis 1008 with respect to the base structure 1004. The mooring system 1000 can also include a yoke structure or simply a “yoke” 1009 that can have a first end 1010 and a second end 1011. The yoke 1009 can be a fabricated, e.g., steel, structure. In some embodiments, the first end 1010 of the yoke 1009 can be configured to connect to the turntable 1007 in a manner that can permit the yoke 1009 to at least partially rotate about a longitudinal axis or roll axis 1012 of the yoke 1009. In some embodiments, the yoke 1009 can also be configured to connect to the turntable 1007 in a manner that can permit the yoke 1009 to at least partially rotate or rotate about a second axis or pitch axis 1013, which can be normal to the plane of FIG. 16, that can be orthogonal or substantially orthogonal or perpendicular or substantially perpendicular to the longitudinal axis 1012 of the yoke 1009. In some embodiments, the second axis 1013 can be within +/−10 degrees, +/−5 degrees, +/−3 degrees, or +/−1 degree of being orthogonal or perpendicular to the longitudinal axis 1012 of the yoke 1009.

In some embodiments, the connection between the first end 1010 of the yoke 1009 and the turntable 1007 can include a roll bearing, a bushing, or the like 1014. In some embodiments, the roll bearing, bushing, or the like 1014 can be disposed on the first end 1010 of the yoke 1009 (as shown) or on the turntable 1007 or between the first end 1010 and the second end 1011 of the yoke 1009. In some embodiments, the longitudinal axis 1012 of the yoke 1009 can be horizontal or substantially horizontal, e.g., within +/−10 degrees, +/−5 degrees, +/−3 degrees, or +/−1 degree, with respect to a horizontal plane when the vessel 1015 is connected to the turntable 1007 via the mooring system 1000 and is in a neutral or static position with respect to the base structure 1004. In some embodiments, the rotative or rotatable connection between the first end 1010 of the yoke 1009 and the turntable 1007 can include at least one pitch bearing or trunnion arrangement (not visible).

In some embodiments, the yoke 1009 can include a ballast tank, a weight, or a combination thereof 1016 that can be connected toward or at the second end 1011 of the yoke 1009. For simplicity and ease of description a ballast tank will be further used to describe the system, but the use of the term “ballast tank” can be replaced with the term “weight” or a combination of the terms “ballast tank and a weight”. Additionally, the mooring system 1000 will be further described as including the ballast tank 1016. However, it should be understood that the ballast tank 1016 can be an optional component and, as such, not included in some embodiments. The ballast tank 1016 can be configured to contain a ballast material. The ballast tank 1016 can also be a fabricated, e.g., steel, structure. In some embodiments, the yoke 1009 that includes the ballast tank 1016 can be disposed below the surface 1002 of the body of water 1003. The ballast material can have a specific gravity that is greater than that of the water 1003. Examples of ballast material can be or can include, but are not limited to, concrete, sand, aggregate, iron ore, magnetite, rocks, drilling mud, any other material that has a specific gravity greater than that of the water, or any combination or mixture thereof. The weight, if present, can be a body having a fixed mass, e.g., a solid metal body.

The mooring system 1000 can also include at least one link arm 1017 that can be configured to connect the second end 1011 of the yoke 1009, e.g., via the ballast tank 1016, to the vessel 1015. In some embodiments, a single link arm 1017 can include two arms each having a first end connected to the ballast tank 1016 or the second end 1011 of the yoke 1009 where the first end of each arm 1017 converges at the second end thereof such that the single link arm 1017 can include a single connector configured to connect to the vessel 1015. In other embodiments, the mooring system 1000 can include two, three, four, or more link arms 1017 that can be configured to connect the ballast tank 1016 or the second end 1011 of the yoke 1009 to the vessel 1015. It should be understood that the mooring system 1000 can also include two or more link arms 1017. In such embodiments, the mooring system 1000 can include an equal number of lifting devices 1034, lifting lines 1036, mechanical joints 1001, and link arms 1017.

In some embodiments, the link arm 1017 can be or can include one or more elongated rigid structures, one or more chains (as shown), one or more cables, or any other suitable elongated member, or any combination thereof. In some embodiments, a first end 1019 the link arm 1017 can be configured to connect to the ballast tank 1016 or the second end 1011 of the yoke 1009 via a coupler 1021. In some embodiments, the coupler 1021 can be or can include, but is not limited to, universal joints, ball and socket joints, flexible joints that can include a plurality of steel and rubber spherical layers laminated together to provide rotational articulation about two non-parallel axes disposed at each end thereof, a padeye, a tri-plate, or any other suitable coupler. A second end 1023 of the link arm 1017 can be configured to connect to the vessel 1015 via the mechanical joint 1001. In some embodiments, the link arm 1017 can be connected to the ballast tank 1016 or the second end 1011 of the yoke 1009 via the same type of coupler or via different types of couplers. An illustrative commercially available flex joint can include the FLEXJOINT® available from Oil States Industries or a mechanical joint as disclosed in U.S. Patent Application Publication No. 2023/0151846.

In some embodiments, the mooring system 1000, when mooring the vessel 1015 to the base structure 1004 can be at least partially submerged. For example, the base structure 1004, the turntable 1007, the yoke 1009, the ballast tank 1016, and at least a portion of the link arm 1017 can be located below the surface 1002 of the water 1003. In some embodiments, a portion of the link arm 1017 can be located above the surface 1002 of the water 1003 when the vessel 1015 is moored to the base structure 1004 of the mooring system 1000. When the mooring system 1000 is disconnected from the vessel 1015, the link arm 1017 can also be located below the surface 1002 of the water 1003. In another example, the base structure 1004, the turntable 1007, the yoke 1009, the ballast tank 1016, the link arm 1017, and a first component of the mechanical joint 1001 can be located below the surface 1002 of the water 1003 when the vessel 1015 is disconnected from the mooring system 1000.

As noted above, the connector assembly 1001 of the mooring system 1000 can be the connector assembly 100, 200, 1300, 1400, or 1500 described above that can connect the link arm 1017 to the vessel 1015. In some embodiments, the mooring system 1000 can include one, two, three, four, or more of the mechanical joints 1001, with the number of mechanical joints 1001 corresponding to the number of link arms 1017. In some embodiments, the mooring system 1000 can also include one or more fluid swivels 1029 that can include a rotating part disposed on the turntable 1007 and a fixed part disposed on the base structure 1004. The fluid swivel 1029 can include a fixed part (disposed on the base structure 1004, e.g., within a housing 1030 of the base structure 1004) that can be coupled to a rotating part 1031 disposed on the turntable 1007. The fluid swivel 1029 can be configured to provide unlimited rotative fluid connectivity between one or more fluid paths therethrough. In such embodiments, one or more fluid conduits (one is shown, 1032) can be configured to transfer one or more fluids from the fluid swivel 1029 to the vessel 1015 and/or from the vessel 1015 to the fluid swivel 1029. In some embodiments, the vessel 1015 can include a riser porch system 1033 disposed on the vessel 1015. The riser porch system 1033 can be configured to fluidly connect the fluid conduit 1032 to one or more storage tanks or other storage structures disposed on and/or within the vessel 1015. In some embodiments, the fixed part of the fluid swivel 1029 can be in fluid communication with a subsea pipeline or pipeline end manifold 1038.

In some embodiments, the lifting device 1034 can be configured such that a speed at which the lifting device 1034 operates at can be tuned, adjusted, or otherwise correlated to account for a motion of the vessel 1015 that can be caused by wind, waves, swell, and/or current present at a given mooring location. In some embodiments, the lifting device 1034 can be configured such that a speed at which the lifting device 1034 operates at is not tuned, adjusted, or otherwise correlated to account for a motion of the vessel 1015. Said another way, the lifting device 1034 can be configured to lift and lower the link arm 1017 and the yoke 1009 at a speed that is independent from a motion of the vessel 1015.

In some embodiments, the lifting device 1034 and the lifting lines 1036 can be arranged such that they are oriented or positioned such that they are directly above or aligned with a vertical axis 1100 relative to the earth. In some embodiments, the lifting line 1036 can be or include one or more chains, wire ropes, synthetic ropes or a combination thereof. In some embodiments, the lifting device 1034 can be configured to directly connect to the second end 132 of the second arm 130 via the lifting line 1036.

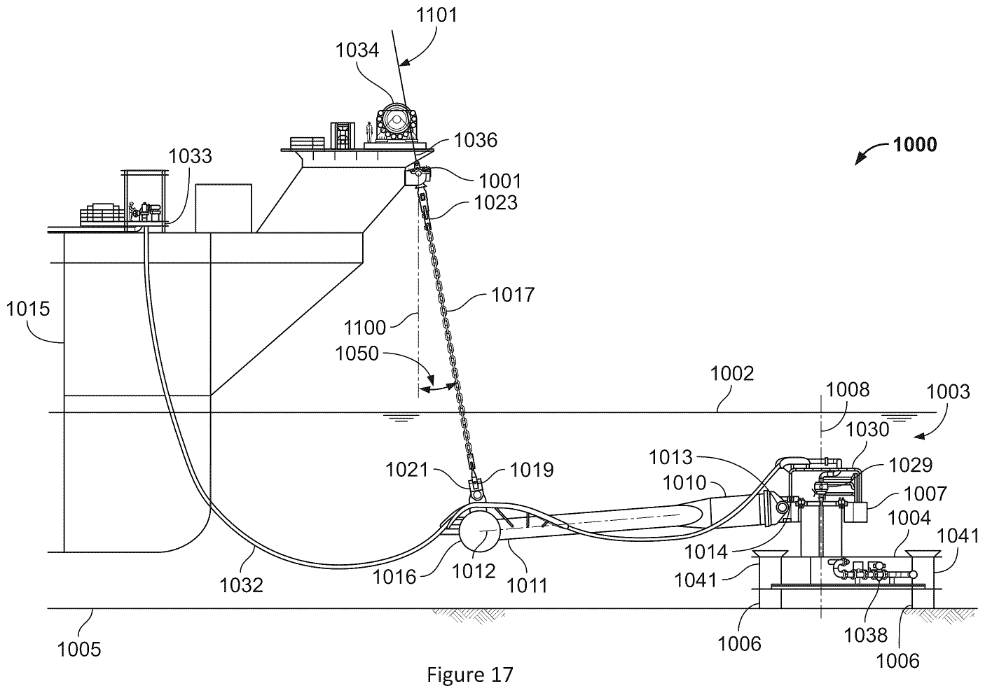

FIG. 17 depicts a side elevation view of the illustrative yoke mooring system 1000 including the mechanical joint 1001, the lifting device 1034, and the lifting line 1036 that are orientated at an angle 1050 relative to the vertical axis 1100 to facilitate the connection and disconnection of the mechanical joint 1001, according to one or more embodiments. FIG. 19 depicts a close-up elevation view of the lifting device 1034, the lifting line 1036, and the mechanical joint 1001 shown in FIG. 17. In some embodiments, the lifting device 1034 and the lifting line 1036 can be aligned along an axis 1101 that can be at an angle 1050 relative to the vertical axis 1100 to facilitate the connection or disconnection operation.

In some embodiments, it can be desirable to connect or disconnect the vessel 1015 from the mooring system 1000 by connecting or disconnecting the mechanical connector 1001 while the vessel 1015 is offset at a distance away from the base structure 1004 such that the link arm 1017 can be at an angle 1050 relative to a vertical axis 1100. In some embodiments, the angle 1050 can be from about 0.5 degrees, about 1 degree, about 3 degrees, about 5 degrees, or about 7 degrees to about 10 degrees, about 15 degrees, about 20 degrees, about 25 degrees, or about 30 degrees. In such embodiments, the mechanical joint 1001, the lifting line 1036, and the lifting device 1034 can be aligned along an axis 1101 that can be at the angle 1050 from the vertical axis 1100. In such an embodiment, the lifting device 1034 can be positioned such that the second arm 130, 1230, 1430, or 1530 of the mechanical joint 1001 can be moved in a direction that is aligned with the longitudinal axis 193 of the first arm 120, 1420, or 1520 so as to minimize interference or friction between the inner surface 127, 1427, or 1527 of the first arm 120, 1420, or 1520 and the second arm 130, 1230, 1430, or 1530. In some embodiments, the mechanical joint 1001, the lifting line 1036, and the lifting device 1034 can be positioned such that the lifting line 1036 can be aligned with the axis 1101 that is tangent to an exterior surface of a drum 1040 of the lifting device 1034 such that that the lifting line 1036 passes through or is aligned with the longitudinal axis 194 of the second arm 130, 1230, 1430, or 1530 as the second arm 130, 1230, 1430, or 1530 is pulled, pushed, or otherwise inserted into the aperture 126, 1426, or 1526 defined by the first arm 120, 1420, or 1520 so as to minimize interference or friction between the inner surface 127, 1427, or 1527 of the first arm 120, 1420, or 1520 and the second arm 130, 1230, 1430, or 1530 and such that the first arm 120, 1420, or 1520 can be aligned with the axis 1101 and the second arm 130, 1230, 1430, or 1530.

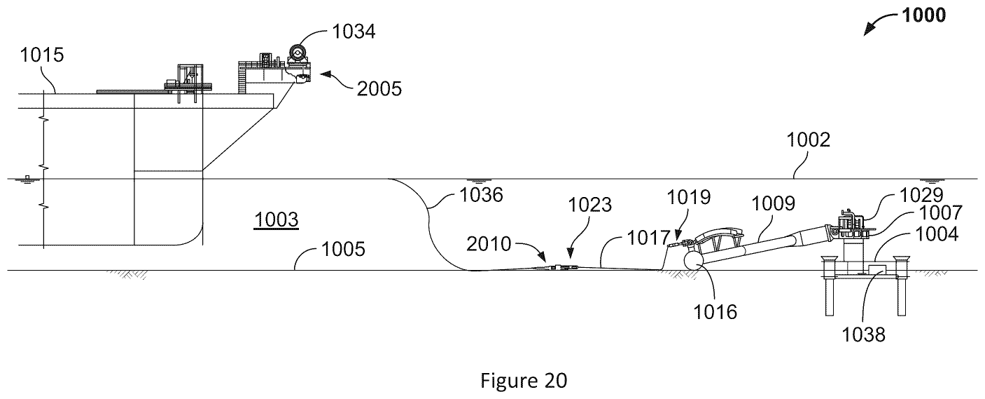

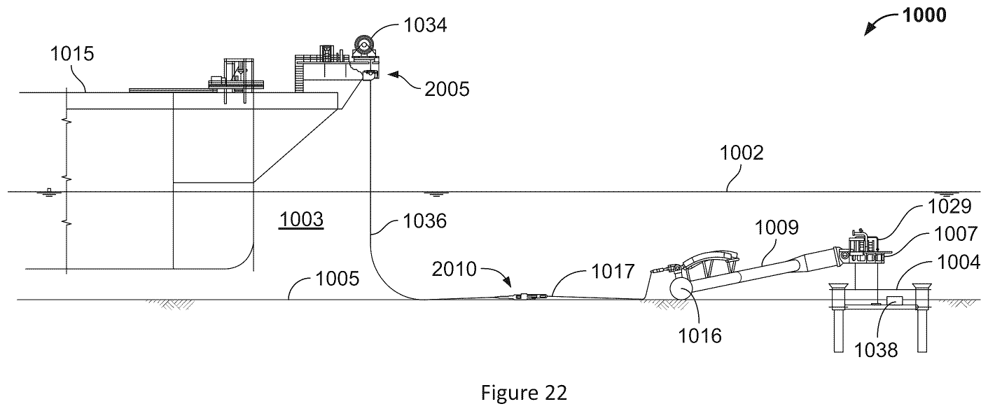

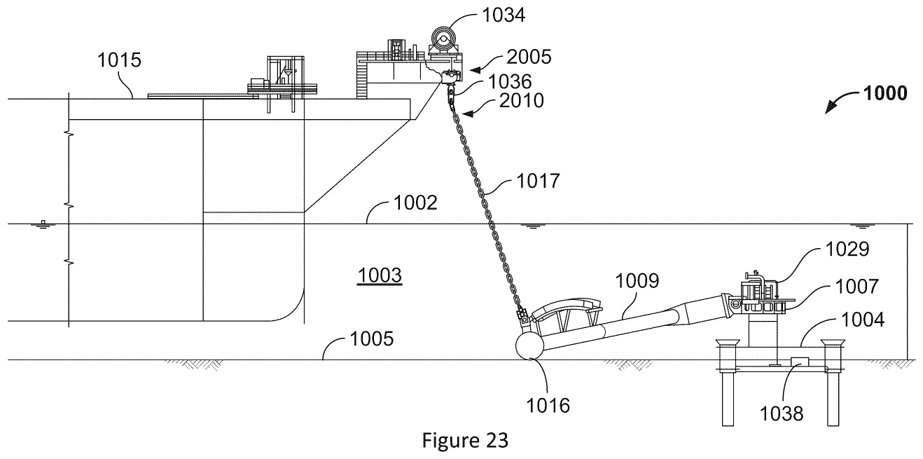

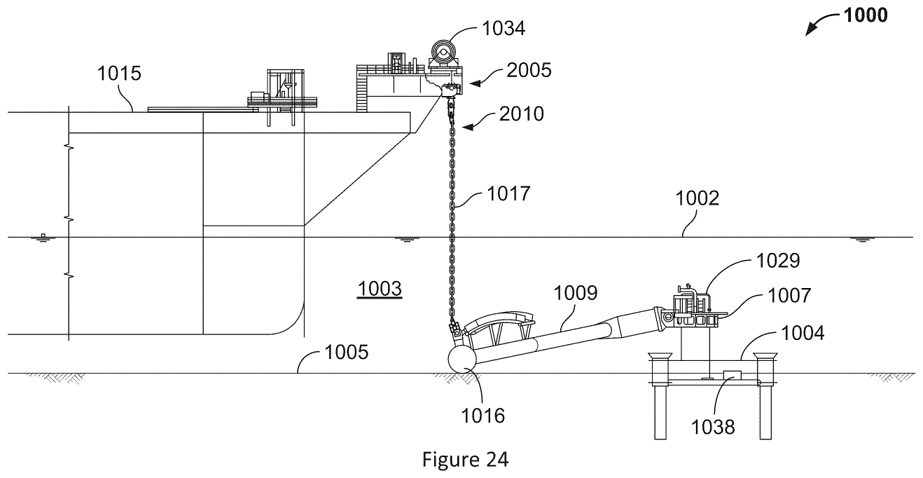

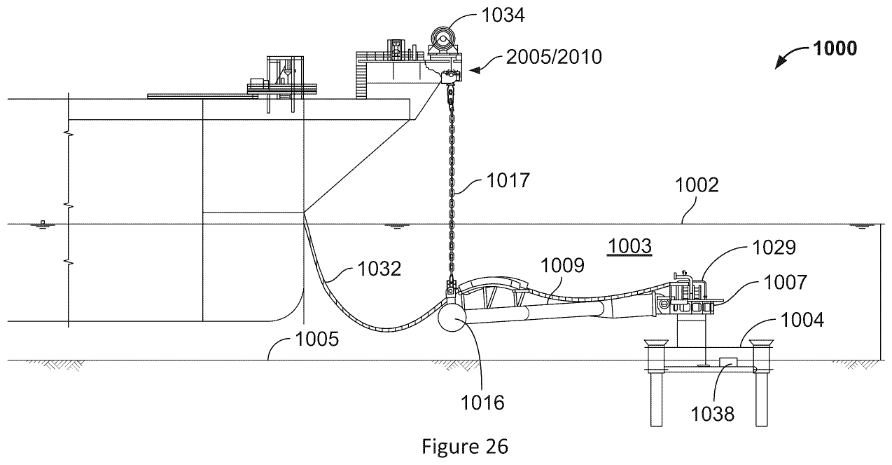

FIGS. 20-26 depict an illustrative connection process for connecting the vessel 1015 floating on the surface 1002 of the body of water 1003 to a structure, e.g., the mooring system 1000, according to one or more embodiments. The process can include maneuvering the vessel 1015 to a position sufficiently close to the mooring system 1000. The vessel 1015 can include a first connector part 2005 of one of the mechanical joints or connector assemblies 100, 1300, 1400, or 1500 described above connected thereto. The first connector part 2005 can include the gimbal table 110, the first arm 120, 1420, or 1520, and the stopper assembly 140, 1440, or 1540 described above. The second end 1023 of the link arm 1017 can include a second connector part 2010 of one of the mechanical joints or connector assemblies 100, 1300, 1400, or 1500 described above connected thereto. The second connector part 2010 can include the second arm 130, 1230, 1430, or 1530 described above. The first end of the link arm 1017 can be attached, secured, or otherwise connected to the yoke 1009 and/or the ballast tank and/or weight 1016. The mooring system 1000 can include the base structure 1004, one or more yokes 1009, and one or more link arms 1017, and, optionally, the one or more ballast tanks and/or weights 1016.

The one or more lifting devices 1034 can be disposed on the vessel 1015. The lifting device(s) 1034 can be used to raise the second connector part 2010 into a connection position with respect to the first connector part 2005 and the first connector part 2005 and the second connector part 2010 can be connected to one another to secure the vessel 1015 to the mooring system 1000. In some embodiments, the lifting line 1036 can be connected to the second connector part 2010 as shown. In other embodiments, the lifting line 1036 can be connected to the link arm 1017 rather than to the second connector part 2010.

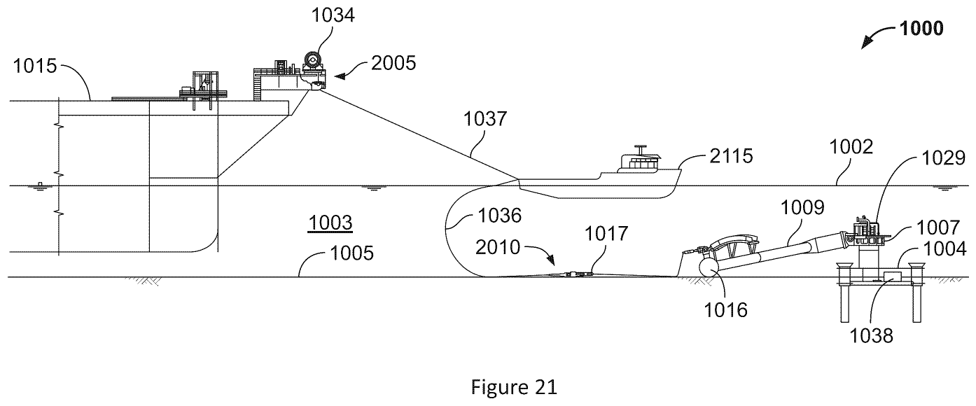

In some embodiments, the vessel 1015 can approach the yoke mooring system 1000 and can retrieve the lifting line 1036 (as shown in FIG. 20) and connect the lifting line 1036 to the lifting device 1034. In other embodiments, the lifting device 1034 can include a second lifting line 1037 connected thereto that can be connected to the lifting line 1036 (as shown in FIG. 21). In some embodiments, as shown in FIG. 21, a support vessel 2115 can be used to facilitate connecting the second lifting line 1037 to the lifting line 1036. It should be understood, however, that use of the support vessel 2115 is optional. At this stage the ballast tank 1016 can be resting on the seabed 1005 or on an optional landing pad (not shown). The link arm 1017 and the second connector part 2010 can also be resting on the seabed 1005 (as shown) or on an optional landing pad (not shown).

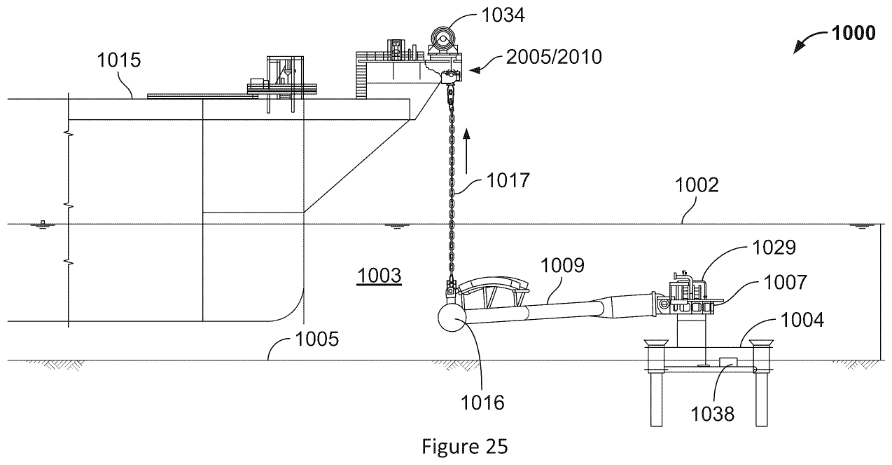

The lifting line 1036 can be pulled in via the lifting device 1034 disposed on the vessel 1015. In some embodiments, the lifting line 1036 can include one or more distance markers thereon that can be used to determine how much lifting line 1036 remains to be pulled in by the lifting device 1034. As the lifting device 1034 pulls the lifting line 1036 onto the vessel 1015, the lifting line 1036 can begin to lift the second end 1023 of the link arm 1017 up off the seabed 1005 and toward the vessel 1015. When the second end 1023 of the link arm has been raised high enough off the seabed 1005 the ballast tank 1016 can begin to be lifted. When the second connector part 2010 reaches the vessel 1015, the second connector part 2010 can be positioned into an engagement position with the first connector part 2005 and connected thereto (FIG. 25).

In some embodiments, the process can include applying a thrust to the vessel 1015 after the lifting line 1036 has been connected to the lifting device 1034 and before or prior to connecting the second connector part 2010 to the first connector part 2005. The thrust can be applied via one or more engines of the vessel 1015 and/or via one or more optional support vessels 2115. In some embodiments, the thrust applied to the vessel 1015 can displace the vessel 1015 to a connection position that can be away from the structure, e.g., the mooring system 1000. In some embodiments, the second connector part 2010 and the first connector part 2005 can be oriented at an angle between about 15 degrees, 20 degrees, 25 degrees, or 30 degrees to 35 degrees, 40 degrees, or 45 degrees of a vertical axis (see FIGS. 17 and 19) when the second connector part 2010 is connected to the first connector part 2005 either due to current or other environmental forces and/or by applying the thrust to the vessel 1015. In some embodiments, after the second connector part 2010 has been connected to the first connector part 2005 the thrust that can optionally be applied to the vessel 1015 can be stopped.

In some embodiments, one or more conduits 1032 can be connected from the vessel 1015 to the fluid swivel 1029. In other embodiments, the fluid conduit(s) 1032 can be connected from the fluid swivel 1029 to the vessel 1015. In such embodiment, the fluid conduit(s) 1032 can remain with the mooring system 1000 when the vessel 1015 is disconnected therefrom. The one or more fluid conduits 1032 can be configured to transfer one or more fluids from the fluid swivel 1029 to the vessel 1015 and/or from the vessel 1015 to the fluid swivel 1029. In some embodiments, the fixed part of the fluid swivel 1029 can be in fluid communication with a subsea pipeline or pipeline end manifold 1038.

In some embodiments, the disconnection process for disconnecting the vessel 1015 from the structure, e.g., the mooring system 1000, can follow the connection process in reverse order. The fluid conduit(s) 1032 can be disconnected from the vessel and/or the fluid swivel 1029. The first connector part 2005 and the second connector part 2010 can be disconnected from one another and the lifting device(s) 1034 can lower the second connector part 2010 along with the yoke 1009, the optional ballast tank 1016, and the link arm 1017 toward the seabed 1005.

In some embodiments, the lifting device 1034 can be used to raise the second connector part 2010 such that a weight or tension applied by the second connector part 2010 to the first connector part 2005 can be reduced or eliminated to facilitate disconnection of the second connector part 2010 from the first connector part 2005. In some embodiments, the second connector part 2010 can be moved relative to the first connector part 2005 in a direction that can lift the structure, e.g., the link arm 1017, away from the seabed 1005. In some embodiments, a thrust can be applied to the vessel 1015 prior to, during, or prior to and during disconnection of the first connector part 2005 from the second connector part 2010. In such embodiment, the second connector part 2010 and the first connector part 2005 can be oriented at an angle of between about 15 degrees, 20 degrees, 25 degrees, or 30 degrees to 35 degrees, 40 degrees, or 45 degrees of a vertical axis (see FIGS. 17 and 19) when the second connector part 2010 is disconnected to the first connector part 2005.

In other embodiments, the second connector part 2010 can be released or otherwise disconnected from the first connector part 2005 without reducing or eliminating any weight or tension applied by the second connector part 2010 to the first connector part 2005. Said another way, in some embodiments, the first connector part 2005 can be supporting the weight or at least a portion of the weight of the structure, e.g., the yoke mooring system 1000, when the second connector part 2010 is disconnected from the first connector part 2005. In some embodiments, the mechanical joint or connector assembly 1400 and/or 1500 can be a preferred connector assembly for disconnecting the second arm 1430 or 1530 from the first arm 1420 or 1520 when the weight or tension applied by the second connector part 2010 to the first connector part 2005 is not reduced or eliminated.

The disconnection process can also include setting the structure, e.g., the yoke 1009, the optional ballast tank 1016, the link arm 1017, and the second connector part on the seabed 1005 or a support structure disposed on the seabed 1005. In some embodiments, the lifting line 1036 can be disconnected from the structure, e.g., the second connector part 2010 or the link arm 1017, or, if present, the lifting line 1037 can be disconnected from the lifting line 1036 once the structure has been set on the seabed 1005. Upon disconnection from the structure, e.g., the mooring system 1000, the vessel 1015 can be maneuvered away from the structure.

In some embodiments, prior to lifting and/or lowering the link arm 1017, the optional ballast tank 1016, and the yoke 1009 toward the vessel 1015 and off the seabed 1005 and/or away from the vessel 1015 and toward the seabed 1005, one or more buoyancy modules disposed on or otherwise connected to the ballast tank 1016 and/or the yoke 1009 can be filled with a fluid, e.g., air, to reduce the weight of the yoke 1009 and the ballast tank 1016. In some embodiments, once the vessel 1001 has been connected to the mooring system 1000, water can be introduced into the one or more buoyancy modules to displace at least a portion of the fluid therefrom.

In some embodiments, prior to lifting and/or lowering the link arm 1017, the optional ballast tank 1016, and the yoke 1009 toward the vessel 1015 and off the seabed 1005 and/or away from the vessel 1015 and toward the seabed 1005, the vessel 1015 can be connected via one or more mooring lines to a mooring buoy that can be configured to assist with connection and disconnection operations of the yoke mooring system 100 to and from the vessel 1015. In some embodiments, the mooring buoy can be connected to the yoke 1009, the turntable 1007, and/or the optional ballast tank 1016. In some embodiments, the mooring buoy can float on the surface 1002 of the body of water 1003. In other embodiments, the mooring buoy can float in the body of water 1003 below the surface 1002 of the body of water 1003. The mooring buoy can be used to assist with mooring operations and, in particular, heading control of the vessel 1015 during the connection process and can be included in any of the embodiments described herein.

In some embodiments, the mooring buoy can be a steel buoy with a tether connecting the mooring buoy to the yoke 1009, the turntable 1007, and/or the ballast tank 1016. The mooring buoy can include a padeye, a hook or other attachment point to attach a mooring line, hawser or other rope from the mooring buoy to the vessel 1015. In this way, the vessel 1015 can be moored to the yoke mooring system 1000 during the connection process and thus reduce or eliminate the number of tug boats or other secondary vessels for the purposes of heading control of the vessel 1015 during the connection process or even eliminate the need for tug boats for the purposes of heading control of the vessel 1015 during the connection process. The vessel 1015 can also be connected to the mooring buoy prior to the disconnection process for the purposes of heading control.

In some embodiments, the yoke mooring system 1000 can also include a mudmat, one or more fenders, or other landing structure(s) integrated with the ballast tank 1016 and/or the yoke 1009. The landing structure can provide a surface for the yoke 1009 and/or the ballast tank 1016 to rest on such that the yoke 1009 or the ballast tank 1016 does not get stuck or adhere to the seabed 1005 which is possible as some seabeds can often have a very soft, muddy consistency. In some embodiments, if the yoke mooring system 1000 includes the landing structure, the landing structure can be at least partially disposed on a bottom surface of the ballast tank 1016.

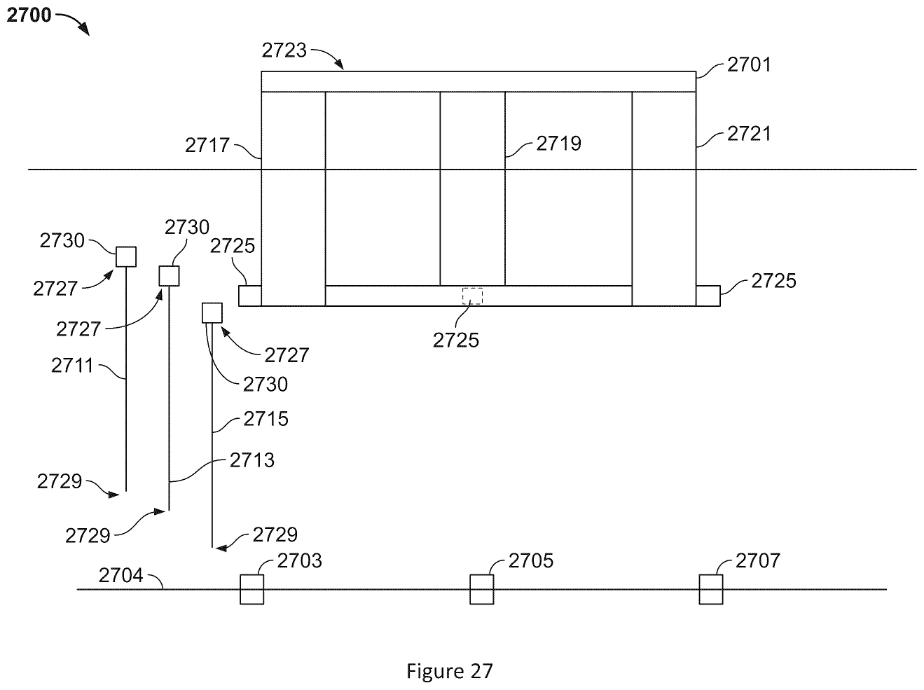

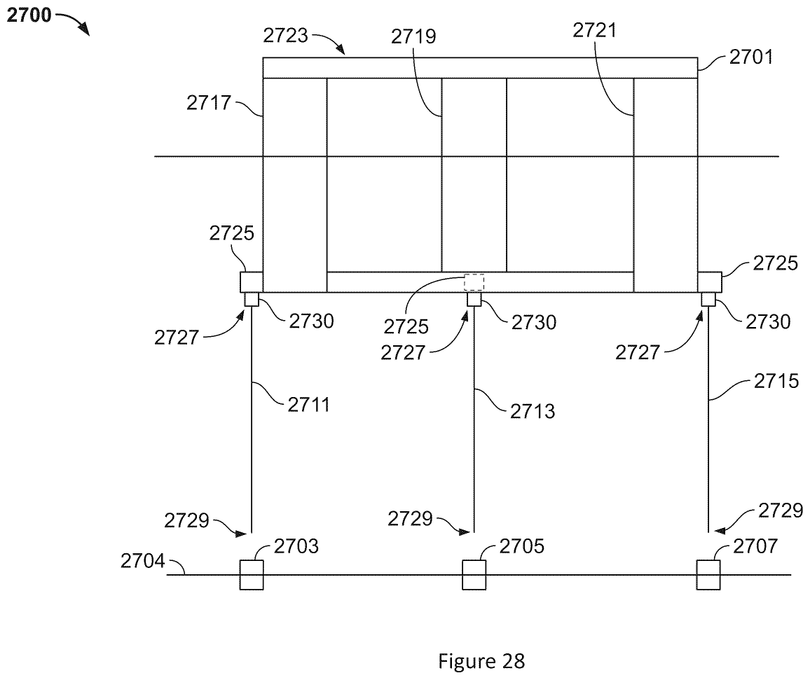

FIGS. 27-32 depict an illustrative process for installing an offshore floating platform system 2700 that includes connecting a floating hull structure 2701 to a plurality of anchors (three are shown, 2703, 2705, 2707) secured to a seabed 2704 via a plurality of mooring lines (three are shown, 2711, 2713, 2715), according to one or more embodiments. In some embodiments, the hull structure 2701 can include a first column 2717, a second column 2719, and a third column 2721 connected to one another. For example, the first, second, and third columns 2717, 2719, 2721 can be fixedly attached to one another via a truss assembly 2723.

In some embodiments, each column 2717, 2719, 2721 can include a first connector part 2725 of one of the mechanical joints or connector assemblies 100, 200, or 1300 described above connected thereto. The first connector part 2725 can include the gimbal table 110, the first arm 120, and the stopper assembly 140 described above.

In some embodiments, a first end 2727 of each mooring line 2711, 2713, 2715 can include a second connector part 2730 of one of the mechanical joints or connector assemblies 100, 200, or 1300 described above connected thereto. The second connector part 2730 can include the second arm 130 or 1230. A second end 2729 of each mooring line 2711, 2713, 2715 can be configured to be attached, secured, or otherwise connected to the first, second, and third anchors 2703, 2705, 2707, respectively.

The process for installing the offshore floating platform system 2700 can include positioning the second arm 130 or 1230 of the of the second connector part 2730 connected to the first mooring line 2711 within the aperture 126 defined by the first arm 120 of the first connector part 2725 connected to the first column 2717 such that one of the plurality of shoulders 133/136 of the second arm 130 or 1233/1234/1235/1236 of the second arm 1230 of the second connector part 2730 connected to the first mooring line 2711 can be engaged with the stopper assembly 140 of the first connector part 2725 connected to the first column 2717.

The process for installing the offshore floating platform system 2700 can also include positioning the second arm 130 or 1230 of the of the second connector part 2730 connected to the second mooring line 2713 within the aperture 126 defined by the first arm 120 of the first connector part 2725 connected to the second column 2719 such that one of the plurality of shoulders 133/136 of the second arm 130 or 1233/1234/1235/1236 of the second arm 1230 of the second connector part 2730 connected to the second mooring line 2713 can be engaged with the stopper assembly 140 of the first connector part 2725 connected to the second column 2719.

The process for installing the offshore floating platform system 2700 can also include positioning the second arm 130 or 1230 of the of the second connector part 2730 connected to the third mooring line 2715 within the aperture 126 defined by the first arm 120 of the first connector part 2725 connected to the third column 2721 such that one of the plurality of shoulders 133/136 of the second arm 130 or 1233/1234/1235/1236 of the second arm 1230 of the second connector part 2730 connected to the third mooring line 2715 can be engaged with the stopper assembly 140 of the first connector part 2725 connected to the third column 2721.

In some embodiments, the process for installing the offshore floating platform system 2700 can also include securing, connecting, or otherwise attaching the second ends 2729 of the first, the second, and the third mooring lines 2711, 2713, 2715, respectively, to the first, the second, and the third anchors 2703, 2705, 2707, respectively. The second ends 2729 of the first, the second, and the third mooring lines 2711, 2713, 2715 can be attached before, during connection of, or after connection of the second connector parts 2730 to the first connector parts 2725.

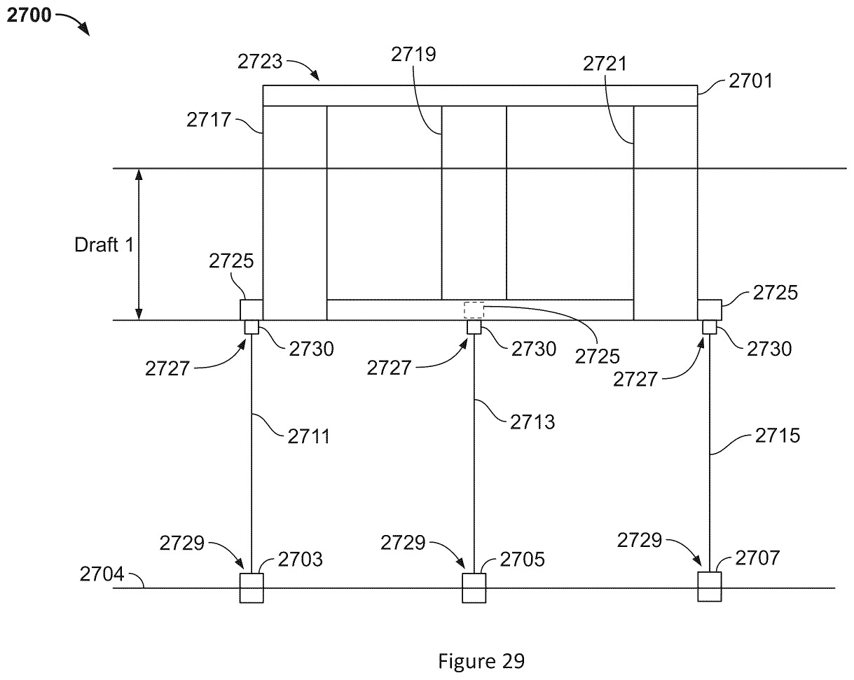

In some embodiments, the process for installing the offshore floating platform system 2700 can also include positioning the hull structure 2701 at a first draft (Draft 1 in FIG. 29) that can be lower than an operating draft prior to positioning the second arm 130 or 1230 of the of the second connector part 2730 connected to the first mooring line 2711 within the aperture 126 defined by the first arm 120 of the first connector part 2725 connected to the first column 2717, positioning the second arm 130 or 1230 of the of the second connector part 2730 connected to the second mooring line 2713 within the aperture 126 defined by the first arm 120 of the first connector part 2725 connected to the second column 2719, and positioning the second arm 130 or 1230 of the of the second connector part 2730 connected to the third mooring line 2715 within the aperture 126 defined by the first arm 120 of the first connector part 2725 connected to the third column 2721.

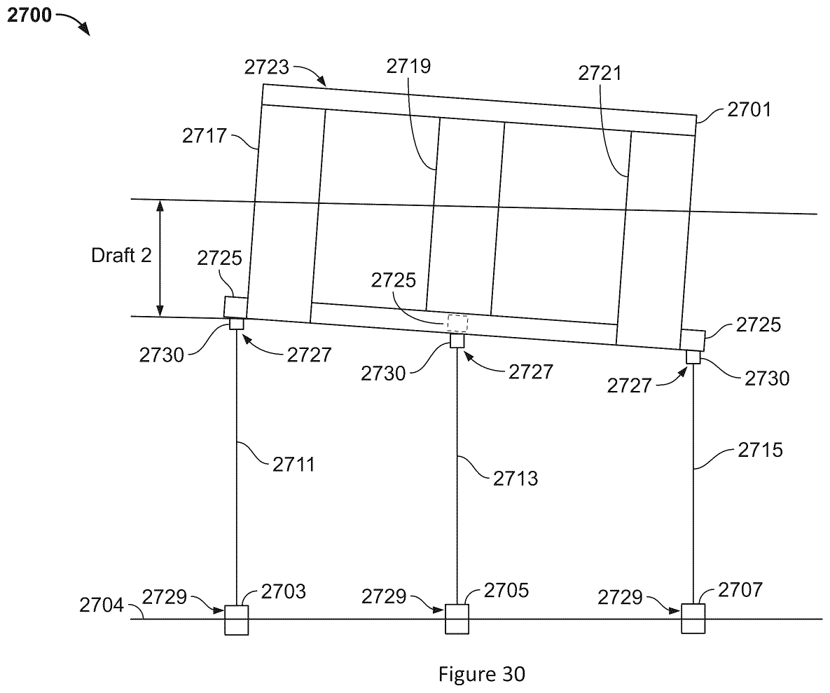

In some embodiments, the process for installing the offshore floating platform system 2700 can also include positioning the hull structure 2701 at a second draft (Draft 2 in FIG. 30) such that the first mooring line 2711, the second mooring line 2713, and the third mooring line 2715 are each subject to a tensile load. In some embodiments, the process for installing the offshore floating platform system 2700 can also include measuring at least one of: a pitch angle of the hull structure 2701, a roll angle of the hull structure 2701, the tensile load in the first mooring line 2711, the tensile load in the second mooring line 2713, and the tensile load in the third mooring line 2715; and calculating an adjustment length of at least one of the first mooring line 2711, the second mooring line 2713, and the third mooring line 2715. In some embodiments, the process for installing the offshore floating platform system 2700 can also include adjusting the length of at least one of: the first mooring line 2711, the second mooring line 2713, and the third mooring line 2715 such that the pitch angle and the roll angle of the hull structure 2701 can each be within a specified angular tolerance when the hull structure 2701 is positioned at the operating draft.

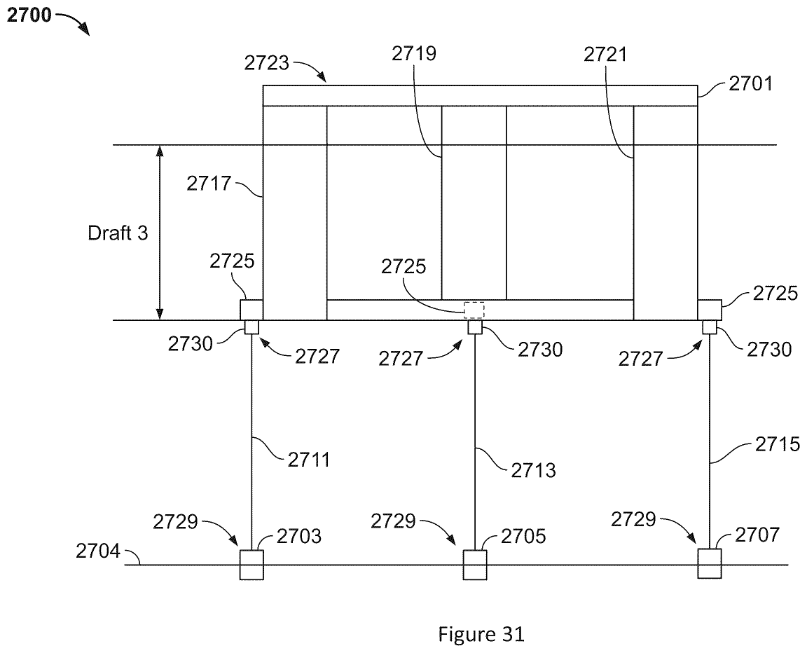

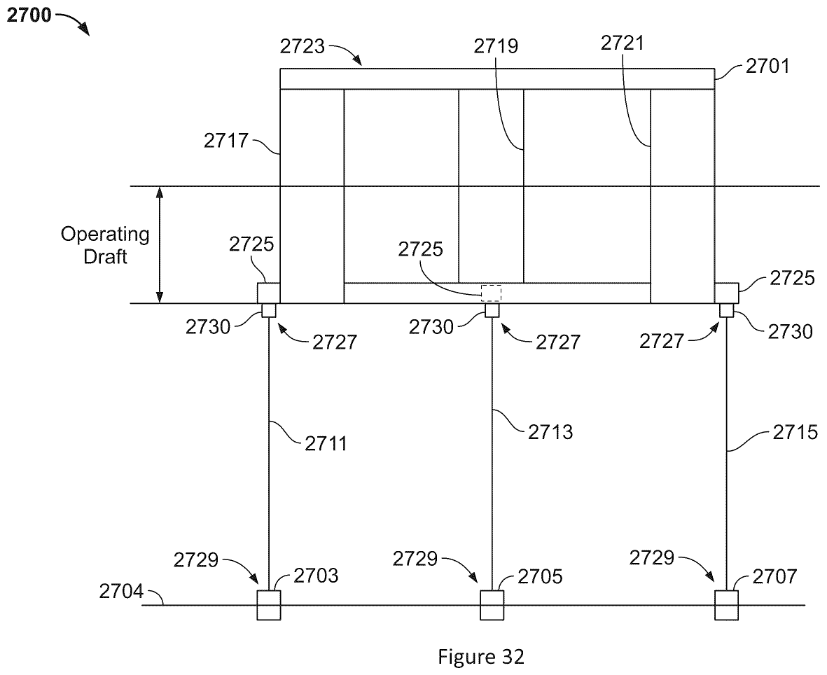

In some embodiments, the process for installing the offshore floating platform system 2700 can also include positioning the hull structure 2701 at a third draft (Draft 3 in FIG. 31) that is lower than the second draft prior to adjusting the length of at least one of: the first mooring line 2711, the second mooring line 2713, and the third mooring line 2715. In some embodiments, the process for installing the offshore floating platform system 2700 can also include adjusting the length of the at least one of: the first mooring line 2711, the second mooring line 2713, and the third mooring line 2715 can include adjusting a position of the second arm 130 or 1230 relative to the first arm 120 to cause another one of the plurality of shoulders 133/136 of the second arm 130 or 1233/1234/1235/1236 of the second arm 1230 to engage with the stopper assembly 140. In some embodiments, the process for installing the offshore floating platform system 2700 can also include positioning the hull structure 2701 at the operating draft (Operating Draft in FIG. 32). In some embodiments, the process for installing the offshore floating platform system 2700 can also include the second draft (Draft 2 in FIG. 30) being substantially equal to the operating draft. In some embodiments, the process for installing the offshore floating platform system 2700 can also include a tension in the first mooring line 2711, a tension in the second mooring line 2713, and a tension in the third mooring line 2715 being within a specified tension tolerance when the hull structure 2701 is positioned at the operating draft.

In some embodiments, the hull structure 2701 can be positioned at a desired draft, e.g., the first, second, third, and/or operating draft, by adding or removing a ballast material, e.g., water, to and/or from the hull structure 2701. For example, in some embodiments, the truss assembly 2723 can be configured to hold water or other ballast medium and also expel such ballast medium therefrom. In another example, in some embodiments, one or more of the columns 2717, 2719, 2721 can be configured to hold water or other ballast medium and also expel such ballast medium therefrom. In still other embodiments, a ballast medium, e.g., concrete blocks or other heavy material, can be transferred onto and/or off of the hull structure 2701. For example, a vessel can be used to carry a suitable ballast material and a crane or other transfer apparatus can be used to move ballast material from the vessel to the hull structure 2701 and vice versa.

In some embodiments, the hull structure 2701 can be configured to support any number of different types of equipment. In some embodiments, the hull structure 2701 can be configured to support one or more wind turbine generators. In other embodiments, the hull structure 2701 can be configured to support one or more hydrocarbon operations such as drilling, production, and the like. In still other embodiments, the hull structure 2701 can be configured to support equipment associated with any of a number of operations such as the production and/or transfer of electricity, hydrocarbons, chemicals such as ammonia, or the like.

The present disclosure further relates to any one or more of the following numbered embodiments:

A1. A connector assembly configured to provide an articulated connection between a first member and a second member, comprising a first connector part and a second connector part, wherein the first connector part comprises: a first bearing block and a second bearing block configured to be disposed on the first member; a gimbal table that defines an aperture therethrough, wherein an upper surface of the gimbal table defines a first bearing surface and a second bearing surface on a first pair of opposing sides of the gimbal table; a first trunnion and a second trunnion disposed on a second pair of opposing sides of the gimbal table; a first arm having a first end and a second end; and a stopper assembly disposed on the first arm, wherein: the first arm defines an aperture therethrough from the first end to the second end and a third trunnion and a fourth trunnion are each disposed toward the second end of the first arm, the first trunnion and the second trunnion are aligned along a first axis, the third trunnion and the fourth trunnion are aligned along a second axis, the first axis and the second axis are substantially orthogonal or substantially perpendicular with respect to one another, the first trunnion is rotatively engaged with the first bearing block and the second trunnion is rotatively engaged with the second bearing block, the third trunnion and the first bearing surface are rotatively engaged with one another, the fourth trunnion and the second bearing surface are rotatively engaged with one another, at least a portion of the first arm is disposed through the aperture defined by the gimbal table, and the first arm is rotatable relative to the gimbal table about the second axis; and wherein the second connector part comprises: a second arm having a first end and a second end, wherein: the second arm comprises a plurality of shoulders axially spaced apart from one another between the first end and the second end thereof, and the second arm is configured to be partially disposed within the aperture defined by the first arm such that one of the plurality of shoulders engages with the stopper assembly.

A2. The connector assembly of paragraph A1, wherein the stopper assembly comprises a pair of flapper plates configured to engage with one of the plurality of shoulders of the second arm.

A3. The connector assembly of paragraph A2, wherein the connector assembly is configured to transfer a load from the second arm to the first arm via the pair of flapper plates.

A4. The connector assembly of paragraph A2 or A3, wherein the stopper assembly comprises one or more actuators configured to rotate the pair of flapper plates relative to the first arm.

A5. The connector assembly of any one of paragraphs A1 to A4, wherein the first arm comprises a guide funnel disposed toward the first end thereof.

A6. The connector assembly of paragraph A5, wherein an inner surface of the guide funnel is frustoconical.

A7. The connector assembly of any one of A1 to A6, wherein the second arm is free to rotate relative to the first arm about a central longitudinal axis of the second arm.

A8. The connector assembly of any one of paragraphs A1 to A7, wherein the second arm and the first arm are configured to rotate substantially together relative to the gimbal table about the second axis when the second arm is disposed within the aperture defined by the first arm and the one of the plurality of shoulders of the second arm is engaged with the stopper assembly.

A9. The connector assembly of any one of paragraphs A1 to A8, wherein the second arm comprises a first surface configured to abut with an inner surface of the first arm such that the first arm and the second arm rotate substantially together relative to the gimbal table about the second axis when the second arm is disposed within the aperture defined by the first arm and the one of the plurality of shoulders of the second arm is engaged with the stopper assembly.

A10. The connector assembly of any one of paragraphs A1 to A9, further comprising a plurality of set screws, wherein: the first arm defines a plurality of threaded bores orientated in a radial direction with respect to a longitudinal axis of the first arm, each of the plurality of set screws is configured to be installed into a corresponding one of the plurality of threaded bores defined by the first arm, and the plurality of set screws is configured to fix the second arm relative to the first arm.

B1. A process for lowering a structure from a vessel floating on a surface of a body of water comprising: providing the vessel and the structure, wherein: the vessel comprises a lifting device and a first connector part disposed thereon, wherein the lifting device comprises a lifting line connected thereto, the structure comprises a second connector part connected thereto, wherein the lifting line is configured to be connected to the second connector part or the structure, and the second connector part is releasably connected to the first connector part such that a weight of the structure is transmitted from the second connector part to the first connector part; connecting the lifting line to the second connector part or the structure; disconnecting the second connector part from the first connector part; and lowering the structure with the lifting device and the lifting line toward a seabed.

B2. The process of paragraph B1, further comprising applying a tension to the second connector part or the structure via the lifting device and the lifting line to reduce the weight of the structure that is transmitted from the second connector part to the first connector part prior to disconnecting the second connector part from the first connector part.

B3. The process of paragraph B2, wherein the weight of the structure is completely supported by the lifting device and the lifting line prior to disconnecting the first connector part from the second connector part.

B4. The process of paragraph B3, further comprising moving the second connector part relative to the first connector part in a direction that lifts the structure away from the seabed.

B5. The process of paragraph B1, wherein the first connector part is supporting the weight of the structure when the second connector part is disconnected therefrom.

B6. The process of any one of paragraphs B1 to B5, wherein the lifting device comprises a winch, and wherein the winch is an electrical winch, a hydraulic winch, a diesel driven winch, or a combination thereof.

B7. The process of any one of paragraphs B to B5, wherein the lifting device comprises a winch, wherein the winch is a hydraulic winch comprising a hydraulic motor, and wherein lowering the structure with the winch comprises back driving the hydraulic motor.

B8. The process of any one of paragraphs B1 to B5, wherein the lifting device comprises a winch, and wherein the winch comprises a clutch and lowering the structure with the winch and the lifting line comprises at least partially releasing the clutch.

B9. The process of any one of paragraphs B1 to B8, further comprising applying a thrust to the vessel prior to, during, or prior to and during disconnection of the first connector part from the second connector part.

B10. The process of any one of paragraphs B1 to B9, wherein the second connector part and the first connector part are orientated at an angle of between 20 and 40 degrees of a vertical axis when the second connector part is disconnected from the first part connector part.

B11. The process of any one of paragraphs B1 to B10, further comprising: setting the structure on the seabed or a support structure disposed on the seabed; and disconnecting the lifting line from the elongated member.

B12. The process of any one of paragraphs B1 to B11, wherein the first connector part is the first connector part of paragraph A1 and the second connector part is the second connector part of paragraph A1.

C1. A process for connecting a vessel floating on a surface of a body of water to a structure secured to a seabed, comprising: maneuvering the vessel to a position sufficiently close to the structure, wherein: the vessel comprises a lifting device and a first connector part disposed thereon, and wherein the lifting device comprises a lifting line, the structure comprises a second connector part connected thereto, wherein the lifting line is configured to be connected to the second connector part or the structure, and the second connector part is configured to be releasably connected to the first connector part such that a weight of the structure is transmitted from the second connector part to the first connector part when the second connector part is connected to the first connector part; connecting the lifting line to the second connector part or the structure; raising the second connector part and the structure with the lifting device and the lifting line; and connecting the second connector part to the first connector part.

C2. The process of paragraph C1, further comprising applying a thrust to the vessel after connecting the lifting line to the second connector part or the structure and prior to connecting the second connector part to the first connector part.

C3. The process of paragraph C2, wherein the thrust applied to the vessel displaces the vessel to a connection position that is away from the structure.

C4. The process of any one of paragraphs C1 to C3, wherein the second connector part and the first connector part are orientated at an angle of between 20 and 40 degrees of a vertical axis when the second connector part is connected to the first connector part.

C5. The process of any one of paragraphs C1 to C4, wherein the first connector part is the first connector part of paragraph A1 and the second connector part is the second connector part of paragraph A1.

C6. The process of any one of paragraphs C1 to C5, wherein the structure comprises a link arm connected to a yoke of a yoke mooring system and the second connector part is disposed on the link arm.

C7. The process of paragraph C6, wherein the yoke mooring system further comprises a base structure disposed on the seabed and a turntable connected to the base structure, wherein a first end of the yoke is connected to the turntable and a second end of the yoke is connected to the link arm.

C8. The process of paragraph C1, further comprising applying a thrust to the vessel after connecting the lifting line to the second connector part or the structure and prior to connecting the second connector part to the first connector part, wherein: the structure comprises a link arm connected to a yoke of a yoke mooring system, the second connector part is disposed on the link arm, the yoke is rotatively connected to a turntable connected to a base structure disposed on the seabed, and the thrust is applied to the vessel to displace the vessel to a connection position that is away from the base structure such that the link arm is orientated at an angle of between 20 and 40 degrees of a vertical position.

D1. A process for installing an offshore floating platform, comprising providing an offshore floating system comprising: a hull structure comprising a first column, a second column, and a third column connected to one another, wherein each column comprises a first connector part of a connector assembly connected thereto; a first anchor, a second anchor, and a third anchor secured to the seabed; a first mooring line, a second mooring line, and a third mooring, wherein each mooring line comprises a second connector part of the connector assembly connected to a first end thereof, and wherein a second end of the first, the second, and the third mooring lines are configured to be attached to the first, the second, and the third anchors, respectively, wherein: the first connector part comprises: a first bearing block and a second bearing block disposed on the hull structure; a gimbal table that defines an aperture therethrough, wherein an upper surface of the gimbal table defines a first bearing surface and a second bearing surface on a first pair of opposing sides of the gimbal table; a first trunnion and a second trunnion disposed on a second pair of opposing sides of the gimbal table; a first arm having a first end and a second end; and a stopper assembly disposed on the first arm, wherein: the first arm defines an aperture therethrough from the first end to the second end and a third trunnion and a fourth trunnion are each disposed toward the second end of the first arm, the first trunnion and the second trunnion are aligned along a first axis, the third trunnion and the fourth trunnion are aligned along a second axis, the first axis and the second axis are substantially orthogonal or substantially perpendicular with respect to one another, the first trunnion is rotatively engaged with the first bearing block and the second trunnion is rotatively engaged with the second bearing block, the third trunnion and the first bearing surface are rotatively engaged with one another, the fourth trunnion and the second bearing surface are rotatively engaged with one another, at least a portion of the first arm is disposed through the aperture defined by the gimbal table, and the first arm is rotatable relative to the gimbal table about the second axis; and wherein the second connector part comprises: a second arm having a first end and a second end, wherein: the second arm comprises a plurality of shoulders axially spaced apart from one another between the first end and the second end thereof, and the second arm is configured to be partially disposed within the aperture defined by the first arm such that one of the plurality of shoulders engages with the stopper assembly; positioning the second arm of the second connector part connected to the first mooring line within the aperture defined by the first arm of the first connector part connected to the first column such that one of the plurality of shoulders of the second arm of the second connector part connected to the first mooring line is engaged with the stopper assembly of the first connector part connected to the first column; positioning the second arm of the of the second connector part connected to the second mooring line within the aperture defined by the first arm of the first connector part connected to the second column such that one of the plurality of shoulders of the second arm of the second connector part connected to the second mooring line is engaged with the stopper assembly of the first connector part connected to the second column; and positioning the second arm of the of the second connector part connected to the third mooring line within the aperture defined by the first arm of the first connector part connected to the third column such that one of the plurality of shoulders of the second arm of the second connector part connected to the third mooring line is engaged with the stopper assembly of the first connector part connected to the third column.

D2. The process of paragraph D1 further comprising attaching the second end of the first, the second, and the third mooring lines to the first, the second, and the third anchors, respectively.

D3. The process of paragraph D1 or paragraph D2, further comprising positioning the hull structure at a first draft that is lower than an operating draft prior to positioning the second arm of the of the second connector part connected to the first mooring line within the aperture defined by the first arm of the first connector part connected to the first column, positioning the second arm of the of the second connector part connected to the second mooring line within the aperture defined by the first arm of the first connector part connected to the second column, and positioning the second arm of the of the second connector part connected to the third mooring line within the aperture defined by the first arm of the first connector part connected to the third column.

D4. The process of paragraph D3, further comprising positioning the hull structure at a second draft such that the first mooring line, the second mooring line, and the third mooring line are each subject to a tensile load.

D5. The process of paragraph D4 further comprising: measuring at least one of: a pitch angle of the hull structure, a roll angle of the hull structure, the tensile load in the first mooring line, the tensile load in the second mooring line, and the tensile load in the third mooring line; and calculating an adjustment length of at least one of the first mooring line, the second mooring line, and the third mooring line.

D6. The process of paragraph D5, further comprising: adjusting the length of at least one of: the first mooring line, the second mooring line, and the third mooring line such that the pitch angle and the roll angle of the hull structure are within a specified angular tolerance when the hull structure is positioned at the operating draft.

D7. The process of paragraph D6, further comprising positioning the hull structure at a third draft that is lower than the second draft prior to adjusting the length of at least one of: the first mooring line, the second mooring line, and the third mooring line.

D8. The process of paragraph D6 or paragraph D7, wherein adjusting the length of the at least one of: the first mooring line, the second mooring line, and the third mooring line comprises adjusting a position of the second arm relative to the first arm to cause another one of the plurality of shoulders of the second arm to engage with the stopper assembly.

D9. The process of any one of paragraphs D6 to D8, further comprising positioning the hull structure at the operating draft.

D10. The process of any one of paragraphs D4 to D9, wherein the second draft is substantially equal to the operating draft.

D11. The process of any one of paragraphs D6 to D10, wherein a tension in the first mooring line, a tension in the second mooring line and a tension in the third mooring line is configured to be within a specified tension tolerance when the hull structure is positioned at the operating draft.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim can be not defined above, it should be given the broadest definition persons in the pertinent art have given that term as reflected in at least one printed publication or issued patent. Furthermore, all patents, test procedures, and other documents cited in this application are fully incorporated by reference to the extent such disclosure can be not inconsistent with this application and for all jurisdictions in which such incorporation can be permitted.

While certain preferred embodiments of the present invention have been illustrated and described in detail above, it can be apparent that modifications and adaptations thereof will occur to those having ordinary skill in the art. It should be, therefore, expressly understood that such modifications and adaptations may be devised without departing from the basic scope thereof, and the scope thereof can be determined by the claims that follow.

What is claimed is:

1. A connector assembly configured to provide an articulated connection between a first member and a second member, comprising:
a gimbal table that defines an aperture therethrough, wherein an upper surface of the gimbal table defines a first bearing surface and a second bearing surface on a first pair of opposing sides of the gimbal table;
a first trunnion and a second trunnion disposed on a second pair of opposing sides of the gimbal table;
a first arm having a first end and a second end, wherein the first arm defines an aperture therethrough from the first end to the second end, and wherein a third trunnion and a fourth trunnion are each disposed toward the second end of the first arm,
a stopper assembly disposed on the first arm; and
a second arm having a first end and a second end, wherein the second arm comprises a shoulder or two or more shoulders axially spaced apart from one another between the first end and the second end thereof, wherein:
the first trunnion and the second trunnion are aligned along a first axis,
the third trunnion and the fourth trunnion are aligned along a second axis,
the first axis and the second axis are substantially orthogonal or substantially perpendicular with respect to one another,
the third trunnion and the first bearing surface are rotatively engaged with one another,
the fourth trunnion and the second bearing surface are rotatively engaged with one another,
at least a portion of the first arm is disposed through the aperture defined by the gimbal table,
the first arm is rotatable relative to the gimbal table about the second axis, and
the second arm is configured to be partially disposed within the aperture defined by the first arm such that the shoulder or one of the two or more shoulders of the second arm engages with the stopper assembly.

2. The connector assembly of claim 1, wherein the stopper assembly comprises a pair of flapper plates configured to engage with the shoulder or the one of the two or more shoulders of the second arm.

3. The connector assembly of claim 2, wherein the connector assembly is configured to transfer a load from the second arm to the first arm via the pair of flapper plates.

4. The connector assembly of claim 2, wherein the stopper assembly comprises one or more actuators configured to rotate the pair of flapper plates relative to the first arm.

5. The connector assembly of claim 1, wherein:
the shoulder or each shoulder of the two or more shoulders of the second arm is an upper surface of a groove defined by the second arm such that the second arm defines one or more grooves,
the stopper assembly comprises a split ring and a retainer ring,
the first arm comprises a shoulder disposed on an inner surface of the first arm that defines the aperture therethrough,
the retainer ring is selectively moveable between an unlocked position and a locked position, and
the retainer ring is configured to maintain the split ring partially within one of the one or more grooves defined by the second arm and partially on the shoulder of the first arm to secure the second arm within the aperture defined by the first arm when the retainer ring is in the locked position.

6. The connector assembly of claim 5, further comprising an actuator, wherein the actuator is configured to selectively move the retainer ring from the unlocked position to the locked position or from the locked position to the unlocked position.

7. The connector assembly of claim 5, wherein the one of the one or more grooves is disposed toward the second end of the second arm and the shoulder of the first arm is disposed toward the second end of the first arm.

8. The connector assembly of claim 5, wherein the one of the one or more grooves is disposed toward the first end of the second arm and the shoulder of the first arm is disposed toward the first end of the first arm.

9. The connector assembly of claim 1, wherein the first arm comprises a guide funnel disposed toward the first end thereof.

10. The connector assembly of claim 9, wherein an inner surface of the guide funnel is frustoconical.

11. The connector assembly of claim 1, wherein the stopper assembly is configured to transmit a load from the second arm to the first arm or from the first arm to the second arm.

12. The connector assembly of claim 1, wherein the second arm is free to rotate relative to the first arm about a central longitudinal axis of the second arm.

13. The connector assembly of claim 1, wherein the second arm and the first arm are configured to rotate substantially together relative to the gimbal table about the second axis when the second arm is disposed within the aperture defined by the first arm and the shoulder or the one of the two or more shoulders of the second arm is engaged with the stopper assembly.

14. The connector assembly of claim 1, wherein the second arm comprises a first surface configured to abut with an inner surface of the first arm such that the first arm and the second arm rotate substantially together relative to the gimbal table about the second axis when the second arm is disposed within the aperture defined by the first arm and the shoulder or the one of the two or more shoulders of the second arm is engaged with the stopper assembly.

15. The connector assembly of claim 1, further comprising a plurality of set screws, wherein:
the first arm defines a plurality of threaded bores orientated in a radial direction with respect to a longitudinal axis of the first arm,
each of the plurality of set screws is configured to be installed into a corresponding one of the plurality of threaded bores defined by the first arm, and
the plurality of set screws is configured to fix the second arm relative to the first arm.

16. The connector assembly of claim 1, further comprising a first bearing block and a second bearing block configured to be disposed on the first member, wherein the first trunnion is configured to rotatively engage with the first bearing block and the second trunnion is configured to rotatively engage with the second bearing block.

17. The connector assembly of claim 1, further comprising a first bearing cap and a second bearing cap, wherein:
the first bearing cap is attached to the upper surface of the gimbal table and captures the third trunnion between the first bearing surface and an inner surface of the first bearing cap, and
the second bearing cap is attached to the upper surface of the gimbal table and captures the fourth trunnion between the second bearing surface and an inner surface of the second bearing cap.

18. A process for installing an offshore floating platform, comprising:
providing an offshore floating system comprising:
a hull structure comprising a first column, a second column, and a third column connected to one another, wherein each column comprises a first connector part of a corresponding connector assembly connected thereto;
a first anchor, a second anchor, and a third anchor secured to the seabed;
a first mooring line, a second mooring line, and a third mooring, wherein each mooring line comprises a second connector part of the corresponding connector assembly connected to a first end thereof, and wherein a second end of the first, the second, and the third mooring lines is configured to be attached to the first, the second, and the third anchors, respectively, wherein the first connector part comprises:
a first bearing block and a second bearing block disposed on the hull structure;
a gimbal table that defines an aperture therethrough, wherein an upper surface of the gimbal table defines a first bearing surface and a second bearing surface on a first pair of opposing sides of the gimbal table;
a first trunnion and a second trunnion disposed on a second pair of opposing sides of the gimbal table;
a first arm having a first end and a second end; and
a stopper assembly disposed on the first arm, wherein:
the first arm defines an aperture therethrough from the first end to the second end and a third trunnion and a fourth trunnion are each disposed toward the second end of the first arm,
the first trunnion and the second trunnion are aligned along a first axis,
the third trunnion and the fourth trunnion are aligned along a second axis,
the first axis and the second axis are substantially orthogonal or substantially perpendicular with respect to one another,
the first trunnion is rotatively engaged with the first bearing block and the second trunnion is rotatively engaged with the second bearing block,
the third trunnion and the first bearing surface are rotatively engaged with one another,
the fourth trunnion and the second bearing surface are rotatively engaged with one another,
at least a portion of the first arm is disposed through the aperture defined by the gimbal table, and
the first arm is rotatable relative to the gimbal table about the second axis; and
wherein the second connector part comprises:
a second arm having a first end and a second end, wherein:
the second arm comprises a plurality of shoulders axially spaced apart from one another between the first end and the second end thereof, and
the second arm is configured to be partially disposed within the aperture defined by the first arm such that one of the plurality of shoulders engages with the stopper assembly;
positioning the second arm of the second connector part connected to the first mooring line within the aperture defined by the first arm of the first connector part connected to the first column such that one of the plurality of shoulders of the second arm of the second connector part connected to the first mooring line is engaged with the stopper assembly of the first connector part connected to the first column;
positioning the second arm of the of the second connector part connected to the second mooring line within the aperture defined by the first arm of the first connector part connected to the second column such that one of the plurality of shoulders of the second arm of the second connector part connected to the second mooring line is engaged with the stopper assembly of the first connector part connected to the second column; and
positioning the second arm of the of the second connector part connected to the third mooring line within the aperture defined by the first arm of the first connector part connected to the third column such that one of the plurality of shoulders of the second arm of the second connector part connected to the third mooring line is engaged with the stopper assembly of the first connector part connected to the third column.

19. A process for connecting a vessel floating on a surface of a body of water to a structure secured to a seabed, comprising:
maneuvering the vessel to a position sufficiently close to the structure, wherein:
the vessel comprises a lifting device and a first connector part disposed thereon, and wherein the lifting device comprises a lifting line,
the structure comprises a second connector part connected thereto, wherein the lifting line is configured to be connected to the second connector part or the structure, and
the second connector part is configured to be releasably connected to the first connector part such that a weight of the structure is transmitted from the second connector part to the first connector part when the second connector part is connected to the first connector part;
connecting the lifting line to the second connector part or the structure;
raising the second connector part and the structure with the lifting device and the lifting line; and
connecting the second connector part to the first connector part, wherein a thrust is applied to the vessel after connecting the lifting line to the second connector part or the structure and prior to connecting the second connector part to the first connector part.

20. The process of claim 19, wherein the thrust applied to the vessel displaces the vessel to a connection position that is away from the structure.
